(19) United States
(12) Patent Application Publication
(10) Pub. No.: US 2015/0253762 A1
(43) Pub. Date: Sep. 10, 2015

(54) INTEGRATED MANAGEMENT SYSTEM, MANAGEMENT DEVICE, METHOD OF DISPLAYING INFORMATION FOR SUBSTRATE PROCESSING APPARATUS, AND RECORDING MEDIUM

(71) Applicant: HITACHI KOKUSAI ELECTRIC INC., Chiyoda-ku, Tokyo (JP)

(72) Inventors: Minoru Nakano, Toyama-shi (JP); Tsuyoshi Saitoh, Toyama-shi (JP)

(73) Assignee: HITACHI KOKUSAI ELECTRIC INC., Tokyo (JP)

(21) Appl. No.: 14/431,152

(22) PCT Filed: Sep. 24, 2013
(86) PCT No.: PCT/JP2013/075686

§ 371 Date: Mar. 25, 2015

(30) Foreign Application Priority Data
Sep. 26, 2012 (JP) 2012-212553

(51) Int. Cl. G05B 19/418

(52) U.S. Cl. CPC G05B 19/418; G05B 2219/45032

(57) ABSTRACT

An integrated management system including a substrate processing apparatus configured to process a substrate and a management device is provided. The management device includes an accumulation unit configured to accumulate specified information including power consumption information indicating a power consumed in the substrate processing apparatus, gas consumption information indicating a gas consumed in the substrate processing apparatus, or operation information indicating an operation state of the substrate processing apparatus; and a processing display unit configured to acquire predetermined information that meets a predetermined condition from the specified information accumulated in the accumulation unit and calculate at least one among a power consumption consumed in the substrate processing apparatus, an inert gas consumption, and an operation rate of the substrate processing apparatus based on the predetermined information.

### TECHNICAL FIELD

The present disclosure relates to an integrated management system including a management device connected to a substrate processing apparatus that processes a substrate, a management device for managing information indicative of a state of each of at least one substrate processing apparatus, a method of displaying information for a substrate processing apparatus, and a recording medium.

### BACKGROUND

In a substrate processing apparatus, there are a lot of information occurrence points of an information such as data (monitoring data) indicating a temperature, a gas flow rate, or the like, and data (event data) indicating an operation state of the substrate processing apparatus. A management device may be connected to the substrate processing apparatus to exchange data and be used to manage the state of the substrate processing apparatus. The management device is configured to receive, from the substrate processing apparatus, data indicating an operation state of the substrate processing apparatus, data indicating the progress of a process (substrate processing) of the substrate processing apparatus, data indicating a transfer state of a substrate to be processed, or the like, and store each of the received data in an accumulation unit in a readable form. Further, a user and a maintenance personnel (hereinafter, also referred to as an operator) of the substrate processing apparatus may operate the above-mentioned management device and perform analysis by reading predetermined data stored in the accumulation unit.

Meanwhile, there is a recent need to establish energy-saving measures such as power consumption reduction, greenhouse gas reduction, and the like for semiconductor manufacturing factories in which a number of semiconductor manufacturing apparatuses as substrate processing apparatuses, are operated. To establish energy-saving measures, it may be necessary to refer to utility data indicating an apparatus operation rate, power consumption, gas consumption, or the like. The operator may acquire data by properly selecting information that specifies data such as power consumption required for energy-saving measures and input the data into the management device. Then, energy-saving measures may be established by analyzing read data based on a predetermined analysis method.

Here, a system for monitoring (supervising) data such as power consumption and gas consumption required for energy-saving measures may be configured as a separate system that is not related to the quality of products produced by the substrate processing apparatus. For this reason, the system may analyze data merely associated with a part of the substrate processing apparatuses or a part of the substrate processing apparatuses connected to the management device. Thus, there has been difficulty in recognizing various data required for energy-saving measures such as the operation rate, power consumption, and gas consumption of each substrate processing apparatus in semiconductor manufacturing factories where a plurality of substrate processing apparatuses are installed.

### SUMMARY

The present disclosure provides some embodiments of an integrated management system, a management device, a method of displaying information for a substrate processing apparatus, and a recording medium, which are capable of accumulating various data collected from each substrate processing apparatus installed in a semiconductor manufacturing factory, processing the accumulated data into data required to save energy for each substrate processing apparatus, and displaying the same.

According to one embodiment of the present disclosure, there is provided an integrated management system including a substrate processing apparatus configured to process a substrate and a management device, the management device including: an accumulation unit configured to accumulate specified information including power consumption information indicating a power consumed in the substrate processing apparatus, gas consumption information indicating a gas consumed in the substrate processing apparatus, or operation information indicating an operation state of the substrate processing apparatus; and a processing display unit configured to acquire predetermined information that meets a predetermined condition from the specified information accumulated in the accumulation unit and calculate at least one among a power consumption consumed in the substrate processing apparatus, an inert gas consumption, and an operation rate of the substrate processing apparatus based on the predetermined information.

According to another embodiment of the present disclosure, there is provided a management device including: an accumulation unit configured to accumulate specified information including power consumption information indicating a power consumed in a substrate processing apparatus configured to process a substrate, gas consumption information indicating a gas consumed in the substrate processing apparatus, and operation information indicating an operation state of the substrate processing apparatus; and a processing display unit configured to acquire predetermined information that meets a predetermined condition from the specified information accumulated in the accumulation unit and calculate at least one among a power consumption consumed in the substrate processing apparatus, an inert gas consumption, and an apparatus operation rate of the substrate processing apparatus based on the predetermined information.

According to another embodiment of the present disclosure, there is provided a method of displaying information for a substrate processing apparatus, including: accumulating specified information including power consumption information indicating a power consumed in the substrate processing apparatus configured to process a substrate, gas consumption information indicating a gas consumed in the substrate processing apparatus, and operation information indicating an operation state of the substrate processing apparatus; and acquiring predetermined information that meets a predetermined condition from the specified information accumulated in the act of accumulating the specified information, calculating at least one among a power consumption consumed in the substrate processing apparatus, an inert gas consumption, and an apparatus operation rate of the substrate processing apparatus based on the predetermined information, and displaying a calculation result.

According to another embodiment of the present disclosure, there is provided a non-transitory computer-readable recording medium storing an information provision program, including: accumulating specified information including power consumption information indicating a power consumed in a substrate processing apparatus, gas consumption information indicating a gas consumed in the substrate processing apparatus, and operation information indicating an operation state of the substrate processing apparatus by generating a predetermined data table including the specified information; receiving an instruction to acquire predetermined information that meets a predetermined condition and repetitively searching the predetermined data table for the predetermined information; terminating the act of searching for the predetermined information; and calculating at least one among a power consumption consumed in the substrate processing apparatus, an inert gas consumption, and an apparatus operation rate of the substrate processing apparatus, from the predetermined information which is acquired based on the predetermined condition, and displaying a calculation result.

According to the present disclosure in some embodiments, it is possible to provide an integrated management system, a management device, and a method of displaying information for a substrate processing apparatus, which are capable of displaying various kinds of information such as an apparatus operation rate, a power consumption, an inert gas consumption, and the like of respective substrate procession apparatus to recognize various kinds of information indicating a state of energy saving of an overall semiconductor manufacturing factory (or an overall particular area) or a state of energy saving for each substrate processing apparatus installed in a factory. Further, it is possible to contribute to energy-saving measures by analyzing data using the information.

### BRIEF DESCRIPTION OF THE DRAWINGS

FIG. 1 is a schematic configuration view of an integrated management system according to an embodiment of the present disclosure.

FIG. 2 is a schematic configuration view of a management device according to an embodiment of the present disclosure.

FIG. 3 is a schematic view illustrating a command screen according to an embodiment of the present disclosure.

FIG. 4 is a schematic view illustrating a data table created by an accumulation unit according to an embodiment of the present disclosure.

FIG. 5 is a flowchart of the execution of an information provision program by a control unit according to an embodiment of the present disclosure.

FIG. 6 is a schematic view illustrating an overview screen according to an embodiment of the present disclosure.

FIG. 7 is a schematic view illustrating a graph according to an embodiment of the present disclosure.

FIG. 8 is a schematic view illustrating a graph according to an embodiment of the present disclosure.

FIG. 9 is a schematic view illustrating a graph according to an embodiment of the present disclosure.

FIG. 10 is a schematic view illustrating a graph according to an embodiment of the present disclosure.

FIG. 11 is a schematic view illustrating a graph according to an embodiment of the present disclosure.

FIGS. 12A to 12D are schematic views illustrating graphs according to an embodiment of the present disclosure. FIGS. 12A to 12D show data when a radio button for displaying a specific apparatus, e.g., substrate processing apparatus, in calendar days, is pressed. Specifically, FIG. 12A indicates total power consumption of a substrate processing apparatus, FIG. 12B indicates power consumption of a heater, FIG. 12C indicates power consumption of a pump, and FIG. 12D indicates power consumption of a controller.

FIGS. 13A to 13D are schematic views illustrating graphs according to an embodiment of the present disclosure. FIGS. 13A to 13D show data when a radio button for displaying a specific area in calendar weeks is pressed. Specifically, FIG. 13A indicates total power consumption of all substrate processing apparatuses installed within a specific area, FIG. 13B indicates the power consumption of a substrate processing apparatus (apparatus A) installed within the specific area, FIG. 13C indicates the power consumption of a substrate processing apparatus (apparatus B) installed within the specific area, and FIG. 13D indicates power consumption of a substrate processing apparatus (apparatus C) installed within a specific area.

FIG. 14 is a schematic view illustrating a graph according to an embodiment of the present disclosure.

FIG. 15 is a schematic view illustrating a graph according to an embodiment of the present disclosure.

FIG. 16 is a schematic view illustrating a graph according to an embodiment of the present disclosure.

FIG. 17 is a schematic longitudinal sectional configuration view of a vertical processing furnace included in a substrate processing apparatus according to an embodiment of the present disclosure.

FIG. 18 is a schematic configuration view of a management device according to another embodiment of the present disclosure.

FIG. 19 is a longitudinal sectional view of a process chamber of a single-wafer-type apparatus properly used in the present embodiment.

FIG. 20 is a schematic view illustrating an overview screen according to another embodiment of the present disclosure.

FIG. 21 is a flowchart of the execution of an information provision program by a control unit according to a modification of the present disclosure.

### DETAILED DESCRIPTION

### One Embodiment of the Present Disclosure

Hereinafter, one embodiment of the present disclosure is described.

### (1) Configuration of Integrated Management System

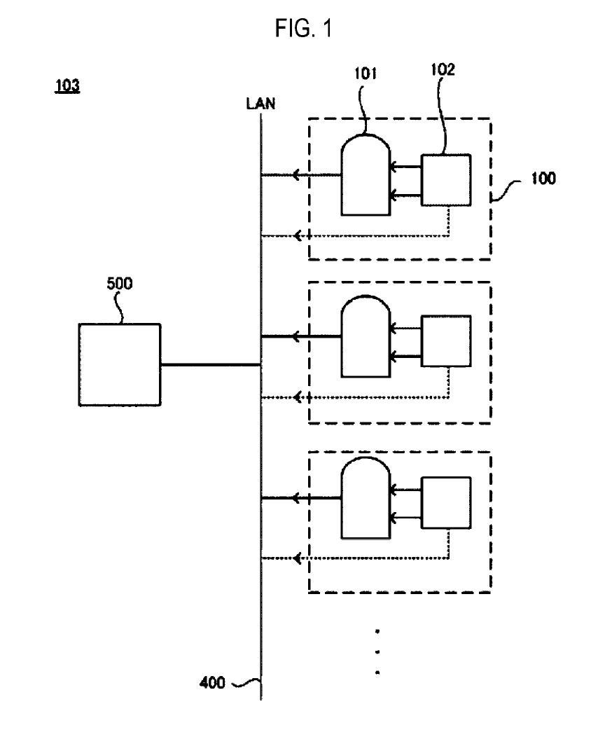

First of all, the configuration of an integrated management system 103 according to the present embodiment is described with reference to FIG. 1. FIG. 1 is a schematic configuration view of the integrated management system 103 according to the present embodiment.

As shown in FIG. 1, in this embodiment, the integrated management system 103 includes a plurality of substrate processing systems 100 and a management device 500 configured to exchange data with the substrate processing systems 100 and serve as an integrated management device for managing the substrate processing systems 100 in an integrated manner. In FIG. 1, each of the substrate processing systems 100 includes a substrate processing apparatus 101 for processing a substrate by executing a recipe in which a processing procedure and processing conditions are defined, and a group management device 102 connected to the substrate processing apparatus 101 to exchange data and serving as a higher-level management device. Further, although FIG. 1 shows one group management device 102 for one substrate processing apparatus 101, the present disclosure is not limited to this configuration. For example, one group management device 102 may be installed for a plurality of substrate processing apparatuses 101. Also, the substrate processing system 100 may have no group management device 102. That is, the substrate processing system 100 may be configured only as the plurality of substrate processing apparatuses 101 (a group of substrate processing apparatuses). Moreover, the integrated management system 103 may be configured to have one group management device 102 installed for the substrate processing systems 100 configured only as the substrate processing apparatuses 101. In addition, as indicated by the dotted lines in FIG. 1, the group management device 102 may be configured to send data directly to an integrated management device 500.

### (2) Configuration of Management Device

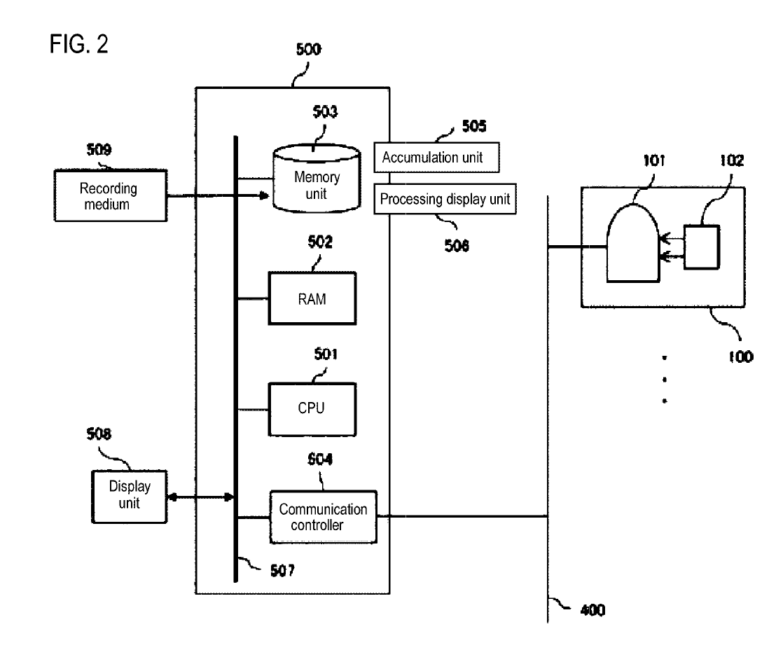

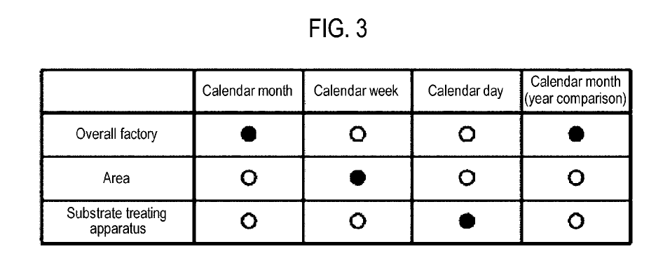

The configuration of the management device 500 according to this embodiment configured to exchange data with the foregoing substrate processing system 100 is described mainly with reference to FIGS. 2 and 3. FIG. 2 is a schematic configuration view of the management device 500 according to the present embodiment. FIG. 3 is a schematic view illustrating a command screen according to the present embodiment.

As shown in FIGS. 1 and 2, the management device 500 is connected to the substrate processing system 100 to exchange data. The substrate processing system 100 and the management device 500 are connected via a network 400 such as a local area network (LAN) or wide area network (WAN), or the like.

The management device 500 includes a control unit 501 configured as a central processing unit (CPU), a memory (RAM) 502 having a memory area therein, a storage unit 503 configured as a storage device such as an HDD, a display unit 508 such as a display device serving as a display means, and a computer having a communication control unit 504 serving as a communication means. The memory 502, the storage unit 503, and the communication control unit 504 as described above are configured to exchange data with the control unit (CPU) 501 via an internal bus 507, or the like. Further, the control unit (CPU) 501 has a clock function (not shown). In addition, the memory 502 is configured as a memory area (work area) where programs, data, and the like read by the control unit (CPU) 501 are temporarily kept. The display unit 508 such as a display device is connected to the management device 500. The display unit 508 is configured as, e.g., a touch panel or the like, and displays such a command screen as shown in FIG. 3, which will be described later, or displays a graph or the like created by a processing display unit 506.

### (Communication Control Unit)

The communication control unit 504 is connected via the network 400 to a controller 280 of the substrate processing system 100 (substrate processing apparatus 101), which will be described later. The communication control unit 504 is configured to receive information such as monitoring data from the substrate processing system 100 and transfer it to the memory 502. The communication control unit 504 may receive information such as monitoring data at regular timings when data is acquired at predetermined intervals (e.g., 0.1 second intervals), at timings when a predetermined event such as the completion of a recipe or step, occurs, for example, or at timings when information is generated.

### (Storage Unit)

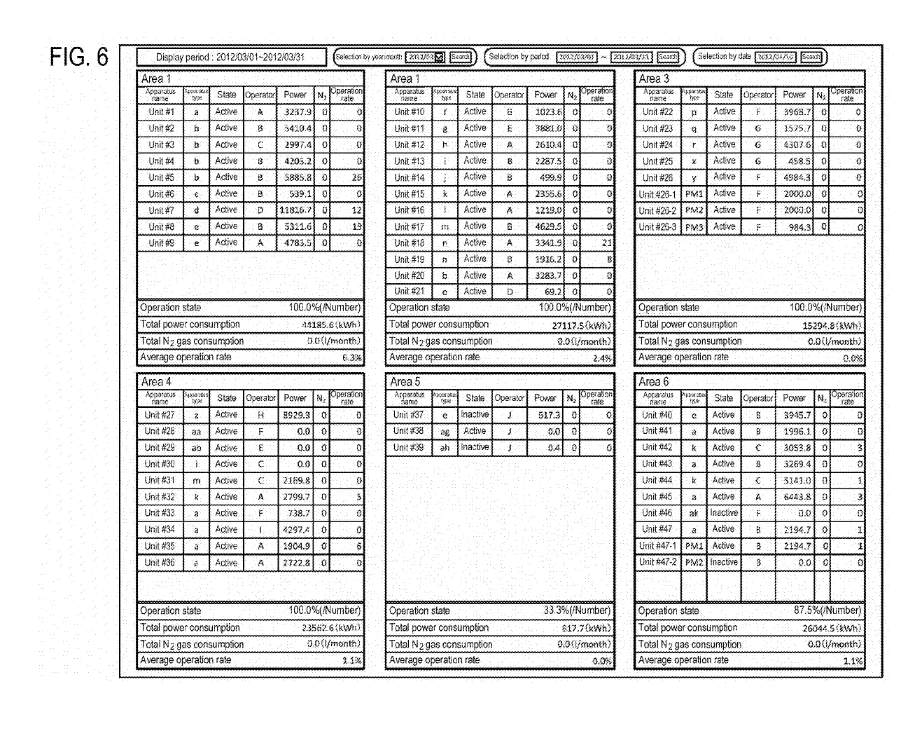

The storage unit 503 includes, for example, a flash memory, a hard disk drive (HDD), or the like. The storage unit 503 stores, for example, a control program for controlling the operation of the substrate processing system 100, a data collection program for collecting information about the substrate processing apparatus 101 from the substrate processing system 100, a data accumulation program for storing predetermined information of the information collected from the substrate processing system 100 in an accumulation unit 505 in a predetermined format, and a recipe that describes a substrate processing procedure, conditions, and the like described later, in a readable manner. Also, the storage unit 503 stores a data analysis program described later. By executing the data analysis program by the control unit 501, a data table stored in the accumulation unit 505, which will be described later, is deployed, and data is processed by the processing display unit 506, thereby displaying, for example, such a command screen as shown in FIG. 3, which will be described later, or such an overview screen as shown in FIG. 6, which will be described later.

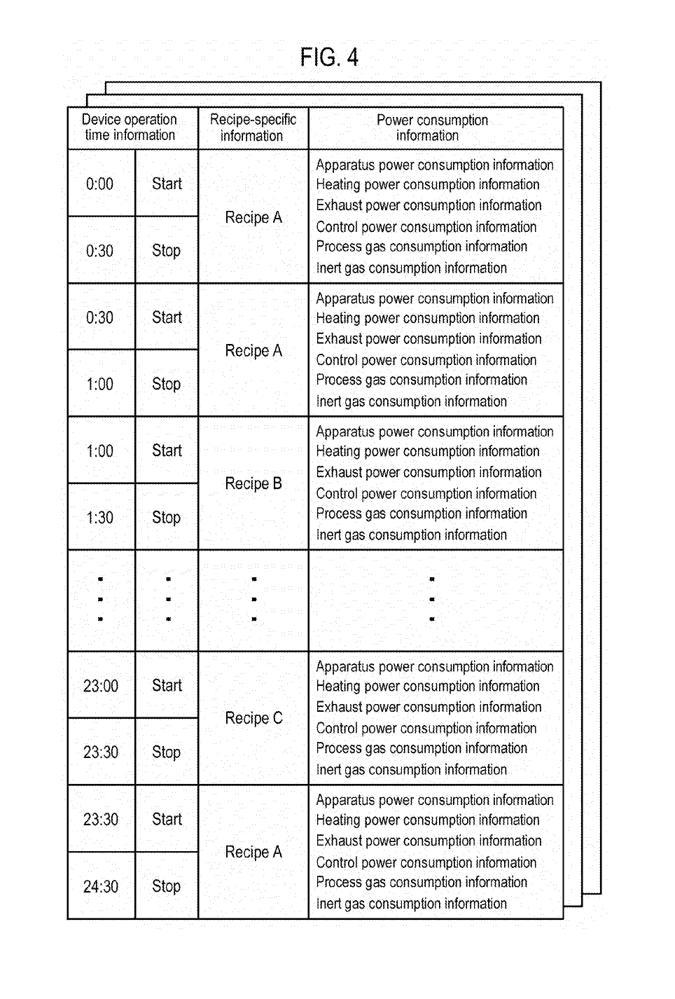

Here, the data accumulation program is a program for managing information accumulated in the accumulation unit 505, which will be described later. For example, the data accumulation program stores predetermined information collected from the substrate processing system 100 in the accumulation unit 505 in a predetermined format in response to a request from the data analysis program. That is, the data accumulation program stores predetermined information collected from the substrate processing system 100 in the accumulation unit 505, for example, a data table as shown in FIG. 4. Also, the data accumulation program is executed by the control unit 501.

Further, the recipe may be configured as a combination of steps of a substrate processing process, which will be described later, for producing specified results when executed by the controller 280 described later. That is, the recipe is a so-called execution table with a structure (sequence) which allows for setting a temperature set value, a gas flow rate set value, and a pressure set value for each time step such that, for example, a substrate processing process such as a film forming process for making the thickness of a formed film coincide with a target value can be performed. A control program for executing the recipe and a transfer program for controlling a transfer mechanism are collectively referred to simply as programs. Further, in this embodiment, the programs include a data accumulation program and a data analysis program (information provision program), as well as the recipe.

Further, the management device 500 may be configured as, but not limited to, a dedicated computer, and may also be configured as a general-purpose computer. For example, the management device 500 according to this embodiment may be configured by preparing a computer-readable recording medium 509 (e.g., a magnetic tape, a magnetic disk such as a flexible disk or hard disk, an optical disk such as a CD or DVD, an optical magnetic disk such as an MO, and a semiconductor memory such as a USB memory or memory card) that stores the above described programs, and installing the programs in a general-purpose computer, e.g., using the recording medium 509. Also, a means for supplying a program to the general-purpose computer is not limited to supplying a program through the recording medium 509. For example, a program may be supplied via a communication means such as the Internet or a dedicated line, rather than through the recording medium 509.

### (Accumulation Unit)

The accumulation unit 505 is configured to acquire information about the substrate processing apparatus 101 from the substrate processing system 100 through the above described memory 502 and accumulate the information in a readable manner. A relational database (RDB), for example, is built as the accumulation unit 505.

Various information (data), such as operation information about an operation state of the substrate processing system 100, power consumption information about power consumed in the substrate processing system 100, and gas consumption information about gas consumed in the substrate processing system 100, may be acquired from the substrate processing system 100 and accumulated in the accumulation unit 505 in a readable manner. FIG. 4 is a schematic view illustrating a data table generated by the accumulation unit 505 according to the present embodiment. In this embodiment, a table is configured as, for example, apparatus operation time information, recipe-specific information, and power consumption information. Further, the management device 500 may include an accumulation means (not shown) corresponding to the accumulation unit 505, aside from the storage unit 503, such that, for example, the information including the operation information, power consumption information, and gas consumption information may be stored in the accumulation means in a predetermined format by executing a data accumulation program. Moreover, the accumulation unit 505 may be implemented by the management device 500 by reading a file such as a table or program stored in the storage unit 503 into the memory 502 and executing the file by the control unit (CPU) 501.

Hereinafter, the data table of FIG. 4 created by the accumulation unit 505 is described in detail.

The operation information may include apparatus-specific information (apparatus name, measurement points that specify areas within a factory, etc.) that specifies the substrate processing apparatus 101 of the substrate processing system 100 in operation, which is a source of information generation, operation time information that specifies an operation start time and an operation stop time of the substrate processing system 100, and recipe-specific information (a recipe name, an execution start time and an execution stop time of a recipe, and a recipe termination state (normal termination or abnormal termination), etc.) that specifies a recipe for substrate processing executed by the substrate processing apparatus 101 of the substrate processing system 100. Also, in this embodiment, an apparatus operation rate (hereinafter, sometimes simply referred to as an operation rate) refers to a ratio of the time during which the substrate processing apparatus 101 of the substrate processing system 100 executes a predetermined recipe for substrate processing per day (24 hours). That is, the substrate processing system 100 (or substrate processing apparatus 101) is not in operation until the start of a next recipe after the termination of a recipe. Thus, the operation time of the substrate processing system 100 (or substrate processing apparatus 101) corresponds to the time during which a recipe for substrate processing is executed (recipe execution time), and an operation start time and an operation stop time of the substrate processing system 100 (or substrate processing apparatus 101) are consistent with the execution start time and the execution stop time of the recipe, respectively.

The power consumption information may include apparatus power consumption information about the substrate processing apparatus 101 and power consumption time information that specifies a power consumption start time and a power consumption stop time of the substrate processing apparatus 101. Further, the power consumption information may include heating power consumption information indicative of power consumption of a heater 270, which is a heating unit of the substrate processing apparatus 101, which will be described later, and heating time information that specifies a power consumption start time and a power consumption stop time of the heater 207, or may include exhaust power consumption information indicating power consumption of a vacuum pump 246, which is an exhaust unit of the substrate processing apparatus 101, which will be described later, and exhaust time information that specifies a power consumption start time and a power consumption stop time of the vacuum pump 246, or may include control power consumption information indicating the power consumption of the controller 280 of the substrate processing apparatus 101, which will be described later, and exhaust time information that specifies a power consumption start time and a power consumption stop time of the controller 280.

The apparatus power consumption information, the heating power consumption information, the exhaust power consumption information, and the control power consumption information indicate, for example, a unit (e.g., kWh or the like) and at least one selected from total power consumption, maximum power consumption, minimum power consumption, and average power consumption of each type during a predetermined interval of data acquisition. Also, in this embodiment, the accumulation unit 505 may acquire and accumulate the average power consumption during a predetermined interval of data acquisition as each type of power consumption information.

The gas consumption information may include inert gas consumption information about an inert gas supply system, which will be described later, and inert gas consumption time information that specifies a consumption start time of an inert gas and a consumption stop time of an inert gas. Also, the gas consumption information may include processed gas consumption information about a process gas supply system described later and process gas consumption time information that specifies a consumption start time of an inert gas and a consumption stop time of a process gas.

The gas consumption information may be indicative of, for example, a unit (e.g., km³, l, or the like) and at least one selected from raw consumption data (measurement value), total power consumption (integrated value), maximum consumption, minimum consumption, and average consumption of an inert gas or process gas during a predetermined interval of data acquisition. Also, in this embodiment, the accumulation unit 505 may acquire and accumulate average gas consumption during a predetermined interval of data acquisition as inert gas or process gas consumption information.

Further, the operation information, the power consumption information, and the gas consumption information may differ from one another in number even during the same predetermined time. That is, the operation information is usually acquired by the hour, by the day, or the like. Also, the intervals of data acquisition of the power consumption information depend on those of data collection by a power sensor, and the power consumption information is usually acquired by the second, or the like, for example. In addition, the gas consumption information depends on intervals of data collection by a gas flow rate sensor and is usually acquired by the second, or the like, for example. The process gas consumption information may be collected at intervals of 1 second or less, depending on the type of substrate processing. For the substrate processing, the inert gas consumption information may be collected at intervals of 1 second or less, depending on the type of substrate processing. Meanwhile, for supplying an inert gas into a transfer chamber from a gas supply unit in order to purge an interior of the transfer chamber connected to a process chamber, the inert gas consumption information is collected by the hour or by the day. In this way, the intervals of data acquisition depend on its usage, purpose, or the like.

Further, although the data table of FIG. 4 includes gas consumption information including process gas consumption information and inert gas consumption information in the item of power consumption information or the like, the present disclosure is not limited thereto. For example, the gas consumption information may fall into other items. In addition, an item such as cooling water flow (supply), for example, may be added, and the present disclosure is not limited to this embodiment.

### (Processing Display Unit)

Upon start-up of the management device 500, a data analysis program similar to a file such as a table or program stored in the storage unit 503, may be read into the memory 502. When the control unit 501 receives a command such as, e.g., a data display request (instruction), from the command screen of FIG. 3, which will be described later, the read data analysis program is executed by the control unit (CPU) 501, thereby implementing the processing display unit 506 by the management device 500. Next, the processing display unit 506 is configured to search the data table built in the accumulation unit 505, and extract specified predetermined information from information including at least one of the operation information, power consumption information, gas consumption information, and the like accumulated in the accumulation unit 505 over a specified predetermined period. And then, the processing display unit 506 is configured to create information serving as an indicator of energy saving by calculating information extracted from the accumulation unit 505, the related time information, and the like, and temporarily keep this information in the memory 502.

Here, the controller 280 serving as a control unit of the substrate processing apparatus 101 described later may have the same configuration as the management device 500. In this case, the controller 280 may have an accumulation unit corresponding to the above described accumulation unit 505, aside from the storage unit 503. Further, the controller 280 may be configured to store information including the above described operation information, power consumption information, gas consumption information, and the like in a predetermined format in the accumulation unit by executing a data accumulation program (not shown), for example. At this time, the controller 280 may include the foregoing processing display unit 506, and the processing display unit 506 of the controller 280 may be implemented by executing a data analysis program. Likewise, a controller serving as a control unit of the group management device 102 may have the same configuration as the management device 500, and this controller may be configured to execute a data accumulation program and a data analysis program.

### (3) Operation of Management Device

Subsequently, an operation of the management device 500 according to the present embodiment is described.

First of all, when the management device 500 is started, each program stored in the storage unit 503 starts running. This executes, for example, a data collection program, which allows the communication control unit 504 to receive various kinds of data including monitoring data or the like with time data added thereto from the substrate processing apparatus 101 and transmit it to the memory 502. Next, the control unit 501 reads information about the substrate processing apparatus 101 stored in the memory 502, and stores it in the accumulation unit 505. In this embodiment, the control unit 501 stores predetermined information in the accumulation unit 505 in a predetermined format (e.g., in the form of the data table shown in FIG. 4) by executing a data accumulation program. Further, the control unit 501 may store predetermined information in the accumulation unit 505 in a predetermined format by executing a data analysis program. Also, when the control unit 501 starts to run the data analysis program, the processing display unit 506 searches the data table for the information stored in the accumulation unit 505 depending on a predetermined condition, and acquires and processes the predetermined information specified under the predetermined condition.

### (Command Screen)

FIG. 3 is a schematic view illustrating a command screen according to the present embodiment. As shown in FIG. 3, the initial setting for a data analysis program is done by pressing a radio button on the command screen. Further, the command screen is configured to display the radio button in a different color when pressed.

Here, an item “overall factory” indicates information about all substrate processing apparatuses 101 installed in a semiconductor manufacturing factory that is within the accumulation unit 505 and that is to be processed and displayed on the display unit 508. Also, not all the substrate processing apparatuses 101 are to be displayed; for example, any substrate processing apparatus that is stopped for periodic maintenance or due to a failure may not be displayed. However, information about all the substrate processing apparatuses 101 installed in the semiconductor manufacturing factory may be displayed.

Further, an item “area” indicates information about all substrate processing apparatuses 101 (or a group of substrate processing apparatuses) installed in a specific area, e.g., floor, in the semiconductor manufacturing factory that is within the accumulation unit 505 and that is to be processed and displayed on the display unit 508. Specifically, in a case where a floor (e.g., the second floor) in a three-story building is divided into three areas: “Area 1”, “Area 2”, and “Area 3”, all the substrate processing apparatuses 101 (or a group of substrate processing apparatuses) installed all over the second floor may be further divided into three areas: “Area 1”, “Area 2”, and “Area 3”, and the items “Area 1”, “Area 2”, and “Area 3” may be displayed on such a command screen as shown in FIG. 3 such that they can be selected.

In addition, an item “substrate processing apparatus” indicates information about a specific substrate processing apparatus 101 installed in a semiconductor manufacturing factory that is within the accumulation unit 505 and that is to be processed and displayed on the display unit 508. At this time, as stated above, other items may be displayed on another screen such that they can be selected. Also, a selection may be made and displayed, for example, by maker, fabrication line, apparatus type, etc.

Furthermore, the items “calendar month”, “calendar week”, and “calendar day” indicate information that is within the accumulation unit 505 and that is to be processed and displayed on the display unit 508 monthly, weekly, and, daily, respectively. That is, a cycle of data search within the accumulation unit 505 is specified by selecting these items. An item “calendar month (year-to-year comparison)” indicates a comparison between this year's information and last year's information, over a predetermined period of time, e.g., six months' from this month.

While the command screen shown in FIG. 3 is displayed in a table form and shows the items “overall factory”, “area”, “substrate processing apparatus”, “calendar month”, “calendar week”, and “calendar day”, the present disclosure is not limited thereto and various modifications may be made. That is, the command screen may be arbitrarily modified, such as adding a new item or deleting an item, for example. Aside from the foregoing commands, other items, for example, “line”, “previous process”, or the like may be displayed. An item “line” indicates information about a plurality of substrate processing apparatuses 101 installed in a predetermined one of semiconductor device manufacturing lines (hereinafter, referred to as manufacturing lines) within a semiconductor manufacturing factory that is acquired from the accumulation unit 505 and that is to be processed and displayed on the display unit 508. An item “previous process” indicates information about substrate processing apparatuses 101, e.g., a film formation device, an annealing device, an oxidation device, and the like, used in the previous process, within a semiconductor manufacturing factory that is acquired from the accumulation unit 505 and that is to be processed and displayed on the display unit 508. Further, an item “subsequent process” may be displayed. The item “subsequent process” indicates information about substrate processing apparatuses 101, e.g., an exposure device, a drying device, an application device, a heating device, and the like, used in the next process, within a semiconductor manufacturing factory that is acquired from the accumulation unit 505 and that is to be processed and displayed on the display unit 508. Moreover, in a case which a semiconductor manufacturing factory is a three-story building, an item “floor 1” indicating substrate processing apparatuses 101 or the like installed on the first floor may be started on the command screen of FIG. 3, and the “floor 2” and the “floor 3” may be displayed such that each floor of the building can be selected. In this case, information about substrate processing apparatuses 101 installed on each floor or information about substrate processing apparatuses 101 is acquired from the accumulation unit 505, and the acquired information is processed and displayed on the display unit 508. In addition, for example, in a case where a plurality of group management devices 102 are disposed in a semiconductor manufacturing factory and there are three layers: management devices 500, group management devices 102, and substrate processing apparatuses 101, for example, an item “management” or the like may be displayed on the command screen of FIG. 3 such that each group management device 102 connected to at least one substrate processing apparatus 101 or the like can be selected. Here, the information about the substrate processing apparatuses 101 includes information (power consumption information, inert gas consumption information, and coolant flow information) about utility consumption data associated with the substrate processing apparatuses 101 or information (recipe-specific information) about a recipe executed on the substrate processing apparatuses 101, as well as the monitoring data and event data.

Further, while the present embodiment is described with respect to a substrate processing apparatus 101 hereinafter, the present disclosure is not limited thereto and apparatuses other than the substrate processing apparatus 101 may also be displayed. For example, a film thickness measuring instrument, a particle counter, or the like may be displayed. Additionally, information regarding substrate processing results (e.g., film thickness, etc.) may be accumulated in the accumulation unit 505.

Subsequently, upon receiving a command, such as, e.g., a data display request (instruction), from the command screen of FIG. 3, the control unit 501 implements the processing display unit 506 by executing a data analysis program. Then, the processing display unit 506 retrieves information about a predetermined substrate processing system 100 over a predetermined period of time specified by the command, from the information accumulated in the accumulation unit 505. Next, the retrieved information and time information related to this information are processed and kept in the memory 502.

For example, the processing display unit 506 calculates the operation rate of the substrate processing apparatus 101 from recipe-specific information (a recipe name, an execution start time of a recipe and an execution stop time of a recipe, and a recipe termination state) that specifies a recipe for substrate processing executed by the substrate processing system 100 (or substrate processing apparatus 101) over a predetermined period.

For example, the processing display unit 506 calculates a total number of operations by calculating the number of times the substrate processing system 100 (or substrate processing apparatus 101) is started up and stopped over a predetermined period, and creates a graph, table, or the like of the calculated total number of operations based on time information related to the predetermined period of time specified by the command and displays it on the display unit 508.

### (Information Provision Program)

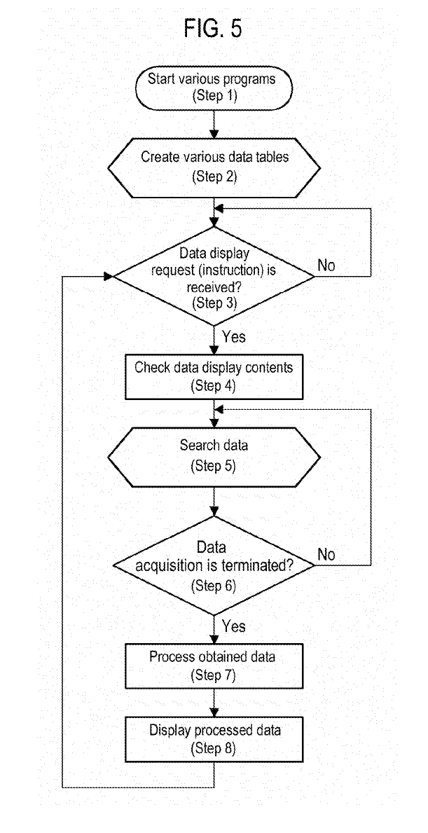

Subsequently, the execution of an information provision program including a data accumulation program and a data analysis program according to the present embodiment is described mainly with reference to FIG. 5. FIG. 5 is a flowchart of the execution of an information provision program including a data analysis program by the control unit 501 (CPU) according to an embodiment of the present disclosure.

First of all, when power is applied to the management device 500, the control unit 501 is started. Then, the control unit 501 acquires various kinds of programs including a data accumulation program and a data analysis program from the storage unit 503. When various kinds of programs acquired by the control unit 501 are sent to the memory 502, the memory 502 reads the programs and the programs are deployed in the memory 502. Then, the programs are started and start running (step 1).

The control unit 501 creates a predetermined data table of utility data such as, e.g., operation information, power consumption information, and inert gas information, in the accumulation unit 505 by executing the data accumulation program. Also, in this embodiment, although not particularly shown, the control unit 501 may also create a data table of data (monitoring data) indicating a temperature, a gas flow, or the like and data (event data) indicating an operation state of the substrate processing apparatus 101 by executing the data accumulation program. Further, the control unit 501 may create a data table by executing not only the data accumulation program but also the data analysis program. That is, the foregoing data table creation function may be added to the data analysis program (step 2).

Subsequently, the data analysis program started by the control unit 501 is deployed in the memory 502 and brought to standby. That is, the display unit 508 displays such a command screen as shown in FIG. 3, waiting for a button such as a radio button to be pressed. Also, in this embodiment, when a predetermined radio button on the command screen of FIG. 3 is pressed, the data analysis program is executed. And then, once a button such as a radio button is pressed and the data analysis program is executed, a data display request (instruction) is sent to the control unit 501 (step 3). Also, the present disclosure is not limited to this embodiment, and, for example, an overview screen of FIG. 6, rather than the command screen of FIG. 3, may be displayed in this step (step 3).

When the button such as a radio button is pressed and the control unit 501 receives the data display request (instruction), the control unit 501 checks the content of the data display request (instruction) data, and derives a predetermined condition (step 4).

Subsequently, the control unit 501 executes the data accumulation program, searches the data table (FIG. 4) in the accumulation unit 505 for predetermined data based on the foregoing predetermined condition, and acquires the predetermined data (information) (step 5). Next, in this embodiment, the control unit 501 receives a search result via the memory 502, and determines whether data acquisition is completed or not (step 6). When the control unit 501 determines that data acquisition is completed, it proceeds to a next step (step 7). When the control unit 501 determines that data acquisition is not completed, it returns to the foregoing step 5. Thereafter, the control unit 501 instructs the data accumulation program to perform a data search, and acquires data that meets the predetermined condition. The same operation is repeated until all the necessary data is acquired. Specifically, a supplementary explanation of the overview screen of FIG. 6 will be provided. In step 5, the information regarding the power consumption, the inert gas consumption, and an apparatus operation rate of the substrate processing apparatus 101 may be acquired, based on such data (data indicating a display period and a display range) as shown in FIG. 3, indicated by pressing the radio button.

When the control unit 501 determines that data acquisition is completed, the control unit 501 executes the data analysis program and processes the acquired data (step 7). For example, the control unit 501 creates data on at least one of the power consumption, the inert gas consumption, and the apparatus operation rate of the substrate processing apparatus 101, over a predetermined period of time, based on to the foregoing predetermined condition. Here, regarding the power consumption, power consumption data per hour, for example, is integrated over 24 hours to create power consumption data per day. Next, the power consumption data per day is integrated over 7 days to create power consumption data per week. Also, the power consumption data per day is integrated for 1 month to create power consumption data per month. Further, in some cases, the power consumption data per day may be integrated for 1 year to create power consumption data per year. Likewise, the control unit 501 executes the data analysis program, and creates inert gas consumption data per day or apparatus operation rate data per day and calculates the inert gas consumption and apparatus operation rate of the substrate processing apparatus 101 based on this data. Specifically, inert gas consumption data per year or apparatus operation rate data per year is integrated for one week and then for one month based on a predetermined condition to create the inert gas consumption data and the apparatus operation rate data about the substrate processing apparatus 101. Moreover, data acquired about every substrate processing apparatus 101 installed in the overall factory is processed based on a predetermined condition. In step 7, the overview screen of FIG. 6 shows operation state information (indicating an operation state of substrate processing apparatuses 101 within an area), total power consumption information (indicating the total power consumption of all the substrate processing apparatuses 101 arranged within the area), total N₂ gas consumption information (indicating the total N₂ gas consumption of all the substrate processing apparatuses 101 within the area), and average operation rate information (indicating an execution state of a recipe on all the substrate processing apparatuses 101 arranged within the area) that are created over a predetermined display period, based on the information (about the power consumption, inert gas consumption, and apparatus operation rate of the substrate processing apparatus 101) acquired in step 5.

Then, the control unit 501 displays the processed data in a predetermined format, for example, on the display unit 508, based on the above described predetermined condition by executing the data analysis program (step 8). Particularly, when the item “overall factory” and any one of the items “calendar month”, “calendar week”, and “calendar day” are selected in FIG. 3 (command screen), such an overview screen as shown in FIG. 6 is displayed. When the item “area” or the item “substrate processing apparatus” is selected in FIG. 3 (command screen), predetermined data (information) is displayed in a graph form on the display unit 508. Also, this makes the processed data more visible when it is side by side to power consumption data, inert gas consumption data, and apparatus operation rate data. In addition, the form of a graph to be displayed is not limited to that of this embodiment. Here, when the item “area” and any one of the items “calendar month”, “calendar week”, and “calendar day” are selected, such an overview screen as shown in FIG. 6 may be displayed.

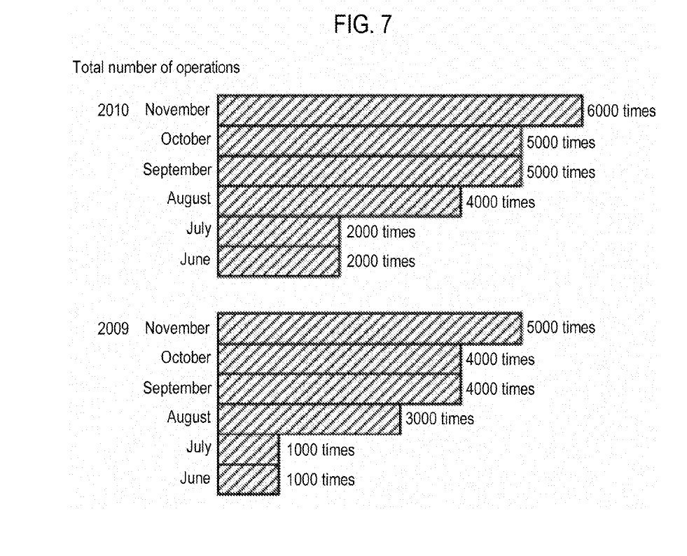

After displaying the processed data in a predetermined format, the control unit 501 returns to the above-described step (step 3) and waits for a next data display request (instruction). Thus, according to this embodiment, the data analysis program is executed by the control unit 501 even if a predetermined button is pressed on the overview screen of FIG. 6 and the graphs of FIGS. 7 to 14, which will be described later. Also, in this embodiment, the information provision programs including such a data accumulation program and a data analysis program may be terminated when the management device 50 is powered off.

### Embodiment 1

### Overview Screen

Subsequently, an example of an overview screen displayed when radio buttons indicating the items “overall factory” and “monthly calendar” are pressed in the command screen illustrated in FIG. 3, as Embodiment 1, is described with reference to FIG. 6. Further, the overview screen is a screen displaying a summary of operation contents of the substrate processing apparatus 101 that meets of the conditions of items selected in the command screen. Here, the operation contents refer to contents regarding information indicating a state of energy saving. Also, although not shown, a flow rate (consumption) of (cooling) water used in the substrate processing apparatus 101 may also be displayed.

Here, in the present embodiment illustrated in FIG. 6, “2012/4/10” is displayed in an item of “selection by date”. Thus, a date on which the overview screen illustrated in FIG. 6 is displayed is Apr. 10, 2012. In this case, a display period is configured as Mar. 1, 2012 to Mar. 31, 2012, as default. This is to make an item “selection by year/month” identical to a case where a search of “2012/03” is pressed. In the screen illustrated in FIG. 6, the display period may be changed from, e.g., Mar. 10, 2012 to Apr. 10, 2012, by changing a setting of “selection by period.” That is, in the screen illustrated in FIG. 6, “selection by year/month” (change in period), “selection by period” (change in period), and “selection by date” (no change in period) are available.

Further, in FIG. 6, it is illustrated that the overall factory is divided into six areas from area 1 to area 6, and a predetermined number of substrate processing apparatuses 101, and the like are disposed in each area. Also, each area may not need to be a so-called clean room for operating the substrate processing apparatuses 101, and may be, for example, an area (e.g., a laboratory, or the like) for developing components (heater 217, or the like) that constitute the substrate processing apparatus 101. Also, there is no need to fix every substrate processing apparatus 101 as a display target, information about every substrate processing apparatus 101 installed in a particular area may be displayed.

In an item “apparatus name,” an apparatus name appears. A name such as, e.g., “unit #28” is generally given to the substrate processing apparatus 101, or the like.

In an item “apparatus type,” a name of an apparatus type appears. In the present embodiment, a name of an apparatus type appears as alphabets. For example, when the same alphabet is given, it indicates that the same substrate processing is performed even though apparatus names are different (for example, the same film is formed). Also, in the present embodiment, for example, alphabet 1 letter denotes a substrate processing apparatus that performs a film forming process, or the like, and alphabet 2 letters denotes a measuring instrument such as a film thickness measuring instrument, a resistance measuring instrument, or a particle counter.

An item “state,” any one being operated or idle appears. Regardless of whether a substrate is loaded into the substrate processing apparatus 101, the substrate processing apparatus 101 is in operation as long as the substrate processing apparatus 101 is not stationary (for example, under maintenance). Also, the item “state” may be discriminatively indicated as being operated and idle. Similarly, as for the foregoing measuring instruments, either an active state or inactive state is displayed in a state in which power is ON or OFF, rather than indicating whether the measuring instruments perform measurement.

In an item “operator,” a maker name, an apparatus manager, or the like appears. In the present embodiment, for example, an apparatus manager is indicated in alphabets, like the item “apparatus type.”

Also, the item “apparatus name,” the item “apparatus type,” and the item “operator” may be appropriately edited. For example, a name of an apparatus type or an apparatus manager may appear through various configurations such as a combination of an alphabet and a number, without being limited to such an alphabet as used in the present embodiment.

In an item “power,” power consumption used by each substrate processing apparatus 101 appears. That is, in FIG. 6, power consumption used from Mar. 1, 2012 to Mar. 31, 2012 appears.

In an item “N₂,” consumption of a nitrogen (N₂) gas used in each substrate processing apparatus 101 appears. That is, in FIG. 6, consumption of an N₂ gas used from Mar. 1, 2012 to Mar. 31, 2012 appears. Also, in FIG. 6, the item “N₂” is all 0, but in actuality, a numerical value is indicated.

An item “operation rate,” an average value of a time (ratio) during which the substrate processing apparatus 101 executes a recipe, in 24 hours (a day), in one month (display period), appears. In FIG. 6, in the operation rate, the average value is indicated as a ratio (%). Also, in a case where the value that appears in the item “operation rate” exceeds a threshold value, the management device 500 may determine that it is abnormal, and indicate it in, e.g., a red color or the like.

Further, as for the item “power,” the item “N₂,” and the item “operation rate,” numerical values may be compared between the same apparatus types, and colors of a maximum numerical value and a minimum numerical value may be differentiated to be displayed. Also, an appropriate threshold value may be determined in advance in each item and, for example, a case where a value that appears in each item exceeds a predetermined threshold value or a case where the value that appears in each item does not exceed the predetermined threshold value may be distinguished in color.

Next, items regarding each area are described. In an item “operation state,” a ratio of the substrate processing system 100 (or the substrate processing apparatus 101) in operation in the item “state” to the substrate processing systems 100 (or the substrate processing apparatuses 101) disposed in each area, appears.

In an item “total power consumption,” the sum of power consumption indicated by the item “power” of each of the substrate processing apparatuses 101 disposed in each area appears. Also, in an item “total N₂ consumption,” the sum of N₂ gas consumption indicated by the item “N₂” of each of the substrate processing apparatuses 101 disposed in each area appears.

In an item “average operation rate,” a value obtained by averaging the sum of numerical values indicated by the item “operation rate” with the number of the substrate processing systems 100 (or the substrate processing apparatuses 101) in operation in each area appears. That is, the value is obtained by (the sum of numerical values indicated by “operation rate” in each area/the number of substrate processing apparatuses 101 in operation in each area)×100.

Further, in the item “apparatus name” that appears in FIG. 6, unit #26 and unit #47 denote single-wafer-type (sheet-type) substrate processing apparatuses. First of all, unit #26 includes three process chambers. Thus, in the item “apparatus name,” names of unit #26-1, unit #26-2, and unit #26-3 are given. Also, in the item “apparatus type,” PM1, PM2, and PM3 are indicated. Here, in the item “power,” power consumption of each process chamber is indicated, and the sum of power consumption of each of unit #26-1, unit #26-2, and unit #26-3 is equal to power consumption of unit #26. Further, the operator is the same person (all indicated by alphabet F), but the operator may be appropriately changed in each process chamber. Also, PM1, PM2, and PM3 are indicated similar to the item “apparatus type,” but they may be appropriately changed. Similarly, each item is indicated in unit #47, and here, in the item “apparatus type” PM1 of the item “apparatus name” 47-1, the item “state” is in operation, but in the item “apparatus type” PM2 of the item “apparatus name” 47-2, the item “state” is idle (under maintenance).

As described above, according to Embodiment 1, various information such as the apparatus operation rate, power consumption, and inert gas consumption of each substrate processing apparatus may be displayed on the screen, and thus, various information indicating a state of energy saving in the overall semiconductor manufacturing factory (or the overall particular area) or a state of energy saving for each substrate processing apparatus installed in the factory can be collectively recognized. Further, by recognizing a detailed state of individual energy saving of the substrate processing apparatuses, or the like installed in the overall semiconductor manufacturing factory (or the overall particular area), and analyzing data by using the information, energy saving measures may be established. For example, energy saving measures such as collecting substrate processing apparatuses 101 having low apparatus operation rate to a single area, and degeneration-operating the substrate processing apparatuses 101 in areas other than the foregoing area may be taken. Accordingly, an energy saving effect can be anticipated in the overall semiconductor manufacturing factory.

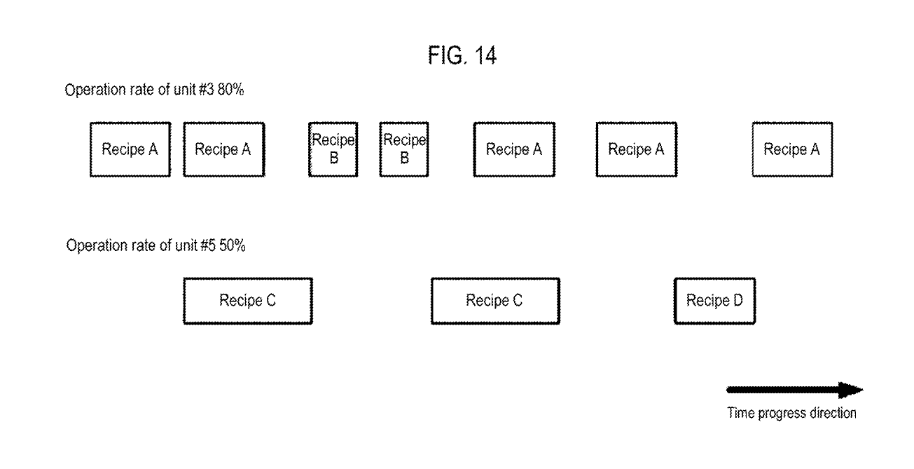

In the overview screen illustrated in FIG. 6, for example, when the item “apparatus name” in the area 1 is pressed, a data analysis program is executed and every apparatus in the area 1 is selected. Here, FIG. 14 illustrates a screen when the unit #3 and unit #5 in the area 1 illustrated in FIG. 6 are selected and the item “operation rate” is then pressed. In FIGS. 6 and 14, even the same unit #3 (or unit #5) has different operation rates, but since the operation rates are different due to, for example, a difference in the display period, and the like in FIG. 6, it is not important.

Further, as illustrated in FIG. 14, the processing display unit 506 may display, for example, an operation state of the substrate processing system 100 (or the substrate processing apparatus 101) of a predetermined period along a time axis. That is, the processing display unit 506 may acquire operation time information of an operation start time and an operation stop time during a predetermined period from an accumulation unit 505, and display the operation start time and the operation stop time along the time axis. At this time, the processing display unit 506 may acquire, for example, a recipe name from recipe-specific information of a predetermined period from the accumulation unit 505 and write the recipe name or acquire apparatus-specific information of a predetermined period from the accumulation unit 505 and write an apparatus name (unit #3, or the like in the present embodiment). Also, an operation rate, or the like of the substrate processing system 100 (or the substrate processing apparatus 101) may be written. Accordingly, a state of energy saving of the substrate processing system 100 (or the substrate processing apparatus 101) can be more rapidly and accurately analyzed, regardless of a skill of an operator.

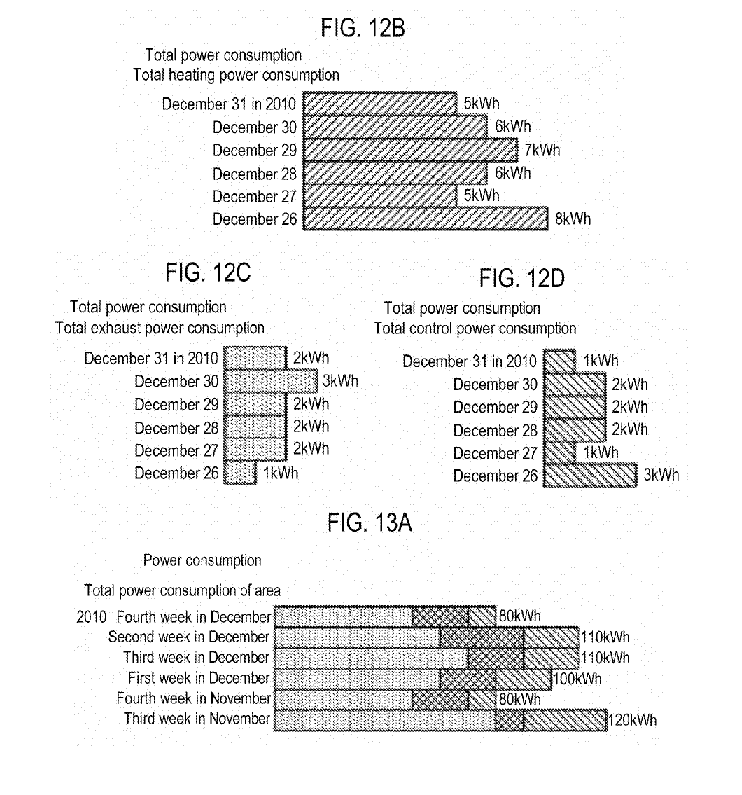

Further, in the overview screen illustrated in FIG. 6, after unit #3 in the area 1 is selected, when the item “power” is pressed, for example, the screen illustrated in FIGS. 12A to 12D, which will be described later, are displayed. Also, FIGS. 12A to 12D illustrate cases where the item “power” is pressed in the display period from Dec. 26, 2012 to Dec. 31, 2012 in FIG. 6.

Further, as illustrated in FIGS. 12A to 12D, for example, the processing display unit 506 calculates total power consumption, total heating power consumption, total exhaust power consumption, and total control power consumption of the substrate processing system 100 (or the substrate processing apparatus 101) at every predetermined period (for example, one day), creates a graph at every predetermined date of the display period, and display the graph on one screen for comparison.

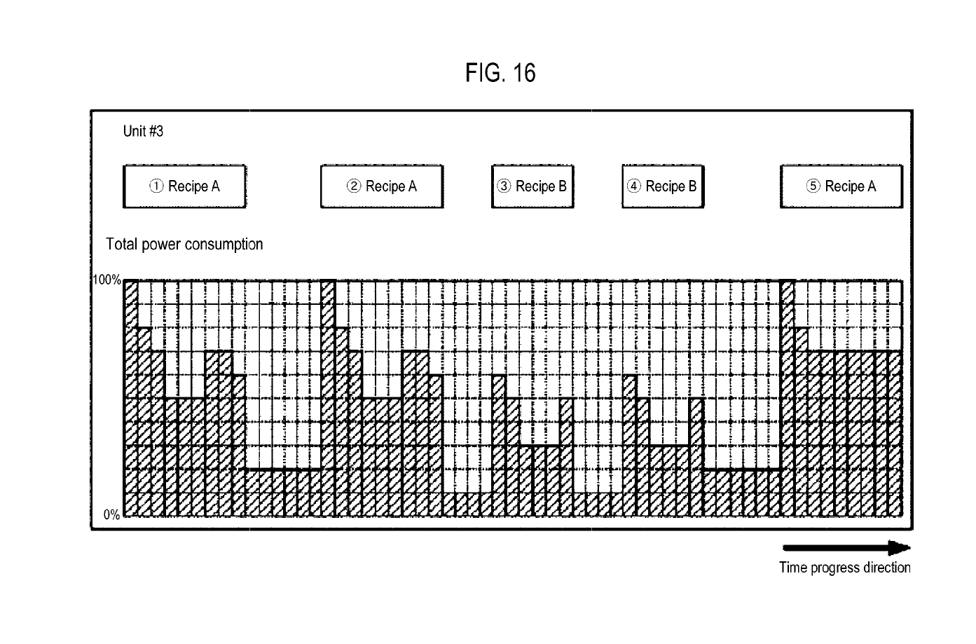

Also, in the overview screen illustrated in FIG. 6, when unit #3 of the area 1 is selected and the item “operation rate” and the item “power” are selected, a data analysis program is executed and, for example, execution history of a recipe and a total power consumption rate illustrated in FIG. 16, which will be described later, are displayed. In addition, in FIG. 16, the set time axis (horizontal axis) may be changed, but basically, it is 24 hours (one day). Also, it may be configured such that when any one of recipe A and recipe B in FIG. 14 is selected, the data analysis program is executed to display a graph of execution history of the selected recipe and power consumption when the recipe is executed in time series as illustrated in FIG. 16.

Further, as illustrated in FIG. 16, the processing display unit 506 may display a total power consumption rate and an operation state of the substrate processing system 100 (or the substrate processing apparatus 101) illustrated in FIG. 14 in time series along the time axis. That is, the processing display unit 506 first acquires apparatus-specific information, operation time information, recipe-specific information, apparatus power consumption information, and power consumption time information over a predetermined period from the accumulation unit 505. Then, the processing display unit 506 calculates a ratio of power consumption per unit time to largest power consumption per unit time in a predetermined period, and determines the value as a power consumption rate. Further, as described above, the processing display unit 506 may create a graph indicating an operation state of the substrate processing system 100 (or the substrate processing apparatus 101) of a predetermined period, and display the same with the graph indicating the power consumption rate per unit time of a predetermined period in time series along the time axis. Also, the graph may not be a power consumption rate per unit time or may indicate power consumption per unit time. Also, vertical lines and horizontal lines may not be present in the graph. Accordingly, a state of the substrate processing system 100 (or the substrate processing apparatus 101) can be more rapidly and accurately analyzed, regardless of a skill of the operator.

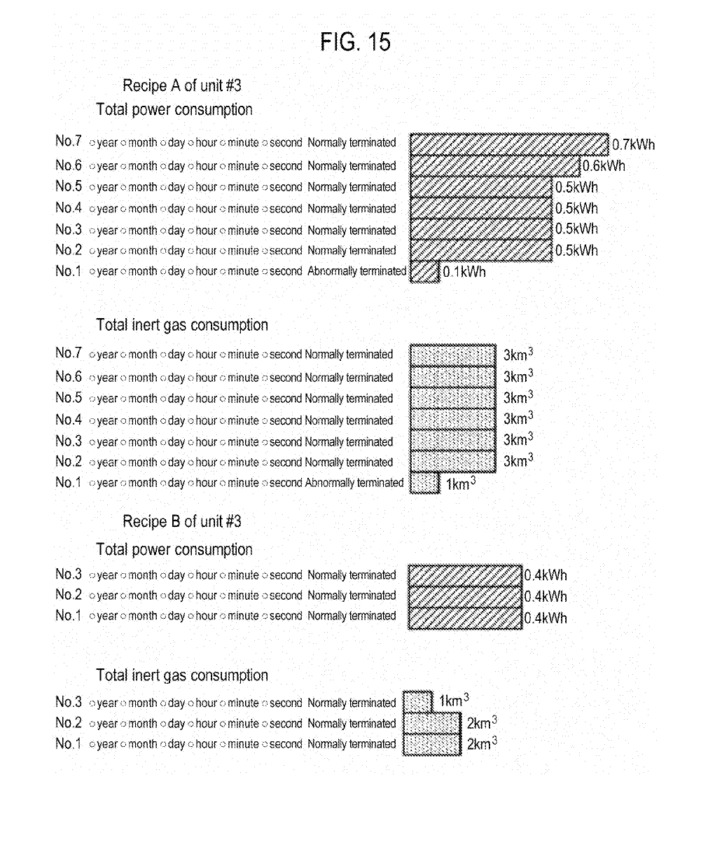

Further, in the overview screen of FIG. 6, when unit #3 of the area 1 is selected and the item “power” and the item “N₂” is selected, the data analysis program is executed and, as illustrated in FIG. 15, total power consumption and total N₂ consumption of each recipe executed by the selected substrate processing apparatus are displayed. Here, as illustrated in FIG. 15, the processing display unit 506 calculates total power consumption and total inert gate consumption of the display period of the substrate processing system 100 (or the substrate processing apparatus 101) for every type of recipe, and displays the same. At this point, as illustrated in FIG. 15, power consumption and inert gas consumption may be calculated in every execution number of the recipe and displayed.

That is, first, the processing display unit 506 acquires apparatus-specific information, operation time information, and recipe-specific information from the accumulation unit 505. As described above, the operation start time and the operation stop time of the operation information of the substrate processing system 100 (or the substrate processing apparatus 101) become the execution start time and the execution stop time of the recipe as it is. Thus, since the recipe is executed one time from the operation start time to the operation stop time of one time, the processing display unit 506 associates the operation start time and the operation stop time with the recipe-specific information and gives an execution number to every type of recipe as in the first of the recipe A—the first of recipe B. Thereafter, the processing display unit 506 determines the duration from the operation start time to the operation stop time (one recipe execution time) as a predetermined period, acquires power consumption information and inert gas consumption information of the predetermined period from the accumulation unit 505, calculates total power consumption and total inert gas consumption of the predetermined period and creates a graph based thereon, and displays the same on one screen for comparison. Accordingly, a state of energy saving of the substrate processing system 100 (or the substrate processing apparatus 101) can be more rapidly and accurately analyzed, regardless of a skill of the operator.

Further, a power consumption graph or an inert gas consumption graph may be created at every predetermined period (recipe execution number) and displayed in one screen for comparison. At this time, the processing display unit 506 may acquire recipe-specific information, write a recipe name or a recipe termination situation (normal termination, abnormal termination, etc.), or acquire apparatus-specific information and write an apparatus name, or write a recipe execution termination time (operation stop time), or the like. Also, without being limited to the graph indicating the total power consumption and total inert gas consumption, the processing display unit 506 may calculate any one of total heating power consumption, total exhaust power consumption, total control power consumption, and total process gas consumption at every type of recipe and every recipe execution time and display the same. Accordingly, a state of energy saving of the substrate processing system 100 (or the substrate processing apparatus 101) can be more rapidly and accurately analyzed, regardless of a skill of the operator.

Also, in the present embodiment, although not particularly described, in FIG. 6, when the item “apparatus type” indicates a substrate processing apparatus (alphabet 1 letter), it may indicate a state of energy saving in the present embodiment. In this case, even when the item “apparatus type” is not a substrate processing apparatus (alphabet 2 letters), it may indicate a target for which the apparatus operation rate (item “operation rate”) is calculated.

Moreover, in the present embodiment, although not particularly described, in FIG. 6, a function of aligning and displaying at every item “apparatus type” and the item “operator” may be installed.

### Embodiment 2

Subsequently, in Embodiment 2, an example of a graph displayed when a radio button for displaying an item “overall factory” in calendar month (year comparison) is pressed in the command screen illustrated in FIG. 3 is illustrated in FIGS. 7 to 11. Further, in FIGS. 7 to 11, it is illustrated such that bar graphs of every month (or biweekly) within a predetermined period are arranged in every year vertically such that year comparison of every month (or every week) can be made. Also, the display form is not limited thereto. In addition, for example, a bar graph of a month (or week) of this year and a bar graph of the same month (or the same week) of last year may be arranged vertically such that year comparison of every month (or every week) can be made. Also, in the graphs illustrated in FIGS. 7 to 11, the data analysis program as described above may be configured to be displayed by the processing display unit 506 that is executed and realized by the control unit 501.

### (Example of Creating Graph of Total Operation Number Graph)

The processing display unit 506 acquires operation time information of a predetermined period (e.g., one month) from the accumulation unit 505, calculates the number of times that the operation start time and the operation stop time have occurred within the predetermined period, and calculates a total operation number of times within the predetermined period. Then, as illustrated in FIG. 7, the processing display unit 506 may create a graph of the calculated total operation number of times of the substrate processing system 100 (or the substrate processing apparatus 101) and display the same such that, for example, a total operation number of times of every month of this year of a predetermined period (e.g., six months) and a total operation number of times of every month of last year are easily compared.

### (Example of Creating Graph of Total Operation Time)

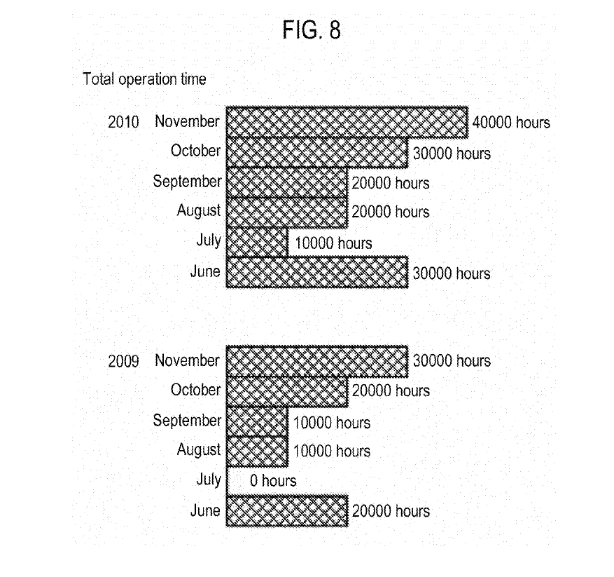

The processing display unit 506 acquires operation time information of a predetermined period (e.g., one month) from the accumulation unit 505 and calculates a total operation time of the predetermined period. Then, as illustrated in FIG. 8, the processing display unit 506 may create a graph of the calculated total operation time of the substrate processing system 100 (or the substrate processing apparatus 101) and display the same such that, for example, a total operation time of every month of this year of a predetermined period (e.g., six months) and a total operation time of every month of last year are easily compared.

### (Example of Creating Graph of Operation Rate)

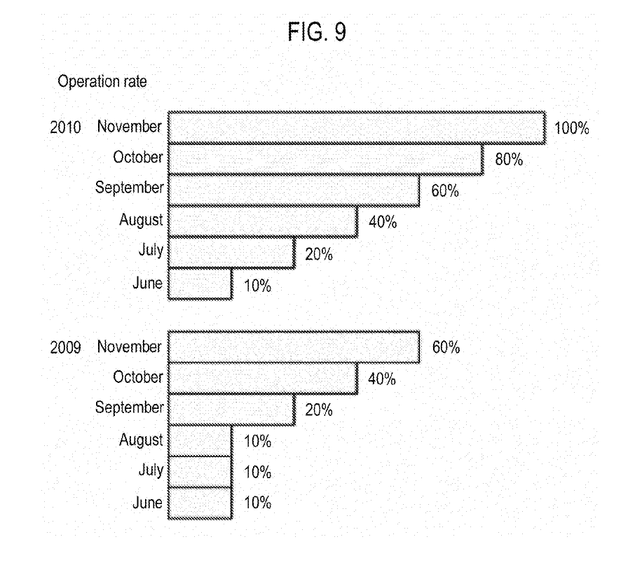

The processing display unit 506 first acquires operation time information of a predetermined period (e.g., one month) from the accumulation unit 505, and calculates a total operation time of the substrate processing system 100 as described above. Thereafter, the processing display unit 506 calculates a ratio of the total operation time to the predetermined period, and determines the ratio as an operation rate. That is, for example, in a case where the predetermined period is 24 hours and the total operation time (recipe execution time) of the substrate processing system 100 is 12 hours, an operation rate of the substrate processing system 100 is 50%. Then, as illustrated in FIG. 9, the processing display unit 506 may create a graph of the calculated operation rate of the substrate processing system 100 (or the substrate processing apparatus 101) and display the same such that, for example, an operation rate of every month of this year of a predetermined period (e.g., six months) and an operation rate of every month of last year are easily compared.

### (Example of Creating Graph of Power Consumption)

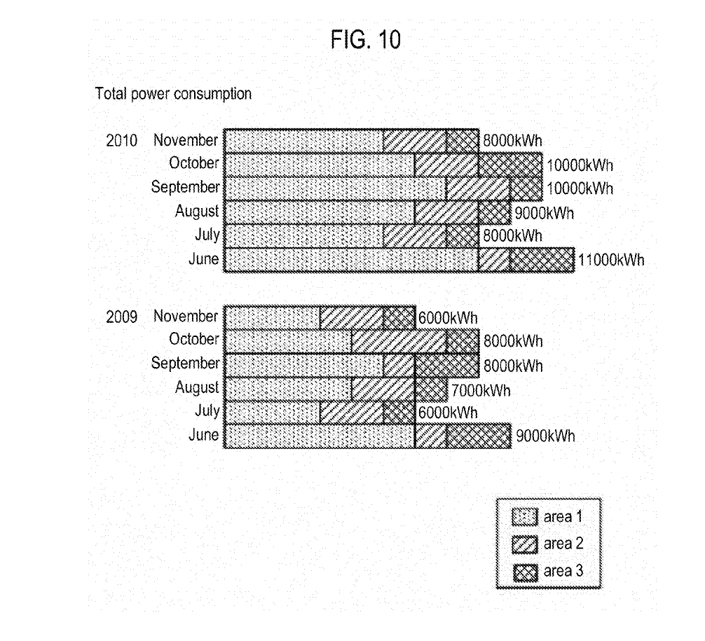

The processing display unit 506 may calculate total power consumption of a predetermined period (e.g., one month) of the substrate processing system 100 (or the substrate processing apparatus 101) and display the same. That is, the processing display unit 506 acquires apparatus power consumption information of a predetermined period from the accumulation unit 505, and calculates a total power consumption of the predetermined period. Then, as illustrated in FIG. 10, the processing display unit 506 may create a graph of the calculated total power consumption of the substrate processing system 100 (or the substrate processing apparatus 101) and display the same such that, for example, power consumption of every month of this year of a predetermined period (e.g., six months) and power consumption of every month of last year are easily compared. Also, in the present embodiment, the semiconductor manufacturing factory in which the plurality of the substrate processing apparatuses 101 are installed is divided into three areas, and total power consumption of a predetermined period of each area is calculated. Then, the sum of the total power consumption of each area is displayed as total power consumption of the overall factory. At this time, as illustrated in FIG. 10, as can be seen in each area, the total power consumption of the overall factory may be distinguished in color for each area, for example.

### (Example of Creating Graph of Total Inert Gas Consumption)

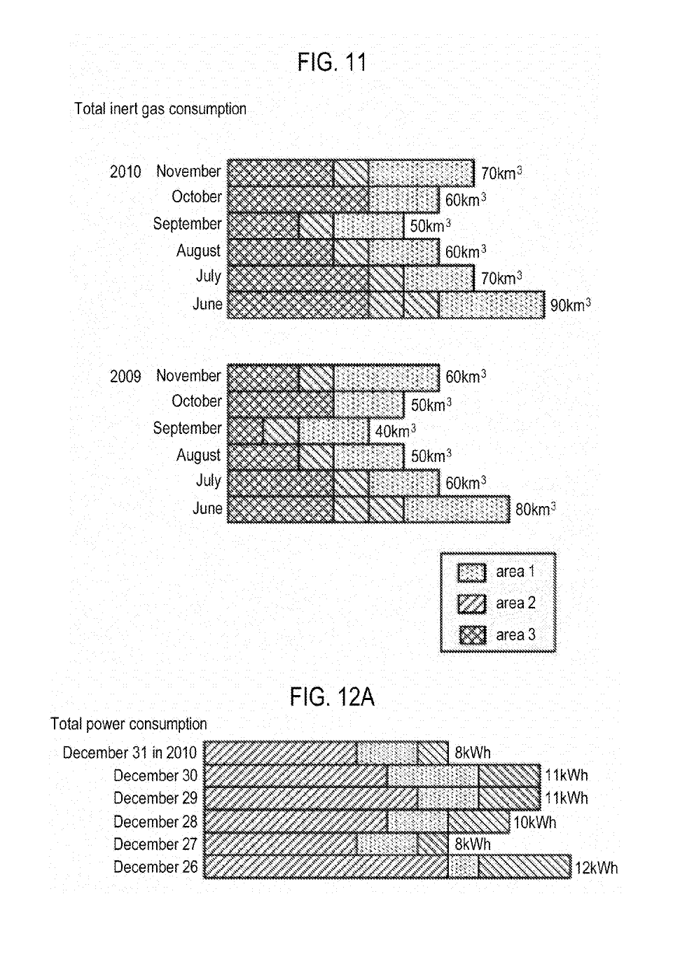

The processing display unit 506 may calculate inert gas consumption of a predetermined period (e.g., one month) of the substrate processing system 100 (or the substrate processing apparatus 101) and display the same. That is, the processing display unit 506 acquires inert gas consumption information of a predetermined period from the accumulation unit 505, and calculates total inert gas consumption of the predetermined period. Then, as illustrated in FIG. 11, the processing display unit 506 may create a graph of the calculated total inert gas consumption and display the same such that, for example, total inert gas consumption of every month of this year of a predetermined period (e.g., six months) and total inert gas consumption of every month of last year are easily compared. Also, in the present embodiment, like in FIG. 10, the semiconductor manufacturing factory is divided into three areas, and inert gas consumption of every month of the overall factory is displayed to be known by each area.

Further, the processing display unit 506 may calculate process gas consumption of a predetermined period of the substrate processing system 100 (or the substrate processing apparatus 101) and display the same. That is, the processing display unit 506 acquires process gas consumption information of a predetermined period from the accumulation unit 505, and calculates total process gas consumption of the predetermined period. Then, the processing display unit 506 may create a graph of the calculated total process gas consumption and display the same. In general, a process gas is used only in a process step (substrate processing step), and thus, consumption of the process gas is extremely small, compared with an inert gas. Thus, even though the consumption of the process gas is monitored, since the effect of carrying out energy saving measures is marginal, it is omitted in the present embodiment.

In this manner, according to Embodiment 2, various kinds of information such as the total power consumption, the total operation number of times, and the like of the substrate processing apparatus 101 are displayed by calendar week, calendar month, and calendar day, and the like, and thus, various kinds of information of the substrate processing apparatus 101 can be recognized and the information may be helpfully used for analyzing data.

### Embodiment 3

Subsequently, examples of a graph displayed in a case where a radio button for displaying the item “substrate processing apparatus” in the calendar day (lapse of month and day of the day-to-day) is pressed in the command screen illustrated in FIG. 3 are illustrated in FIGS. 12A to 12D. Further, when the radio button displayed on the command screen illustrated in FIG. 3 is pressed and the control unit 501 receives a command of a data display request (instruction), the data analysis program is executed to implement the processing display unit 506.

As illustrated in FIG. 12A, the processing display unit 506 calculates total power consumption of the substrate processing apparatus 101 every day, creates a graph and displays the same. In the present embodiment, the total power consumption is the sum of power consumption of the heater 207 described later, power consumption of the vacuum pump 246 described later, and power consumption of the controller 280 described later. Further, power consumption of the heater 207, the vacuum pump 246, and the controller 280 may be separately calculated, and total power consumption of the substrate processing apparatus 101 may be displayed in a color or the like, in every power consumption as illustrated in FIG. 12A.

The processing display unit 506 calculates total heating power consumption as power consumption of a predetermined period (e.g., one day) of the heater 207 described later and displays the same. That is, the processing display unit 506 acquires heating power consumption information of the heater 207 of a predetermined period from the accumulation unit 505, calculates total heating power consumption of the predetermined period, creates a graph of the calculated total heating power consumption and displays the same, as illustrated in FIG. 12B.

The processing display unit 206 calculates total exhaust power consumption as power consumption of a predetermined period (e.g., one day) of the vacuum pump 246 described later and displays the same. That is, the processing display unit 506 acquires exhaust power consumption information of the vacuum pump 246 of a predetermined period from the accumulation unit 505, calculates total exhaust power consumption of the predetermined period, creates a graph of the calculated total exhaust power consumption and displays the same, as illustrated in FIG. 12C.

The processing display unit 206 calculates total control power consumption as power consumption of a predetermined period (e.g., one day) of the controller 280 described later and displays the same. That is, the processing display unit 506 acquires control power consumption information of the controller 280 of a predetermined period from the accumulation unit 505, calculates total control power consumption of the predetermined period, creates a graph of the calculated total control power consumption and displays the same, as illustrated in FIG. 12D.

In this manner, according to Embodiment 3, the total power consumption of the substrate processing apparatus 101 is calculated every day, and created as a graph and displayed, and thus, various kinds of information of the substrate processing apparatus 101 can be recognized and the information may be used for analyzing data. As a result, a state of energy saving of the substrate processing apparatus 101 can be analyzed and energy saving measure can be established, regardless of a skill of the operator.

### Embodiment 4

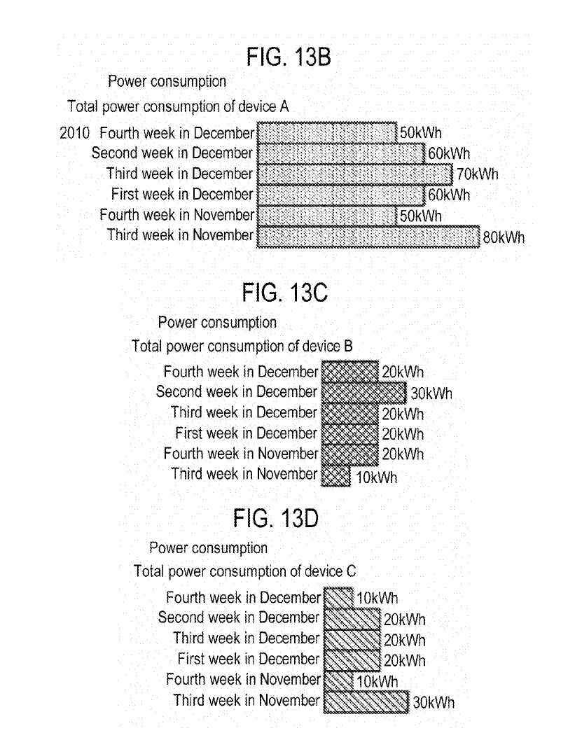

Subsequently, examples of a graph displayed when a radio button for displaying the item “area” in the calendar week (lapse of every one week) is pressed in the command screen illustrated in FIG. 3 are illustrated in FIGS. 13A to 13D. Further, when the radio button displayed on the command screen illustrated in FIG. 3 is pressed and the control unit 501 receives a command of a data display request (instruction), the data analysis program is executed to implement the processing display unit 506.

As illustrated in FIG. 13A, the processing display unit 506 calculates the sum of total power consumption consumed in the substrate processing apparatus 101 (or a group of the substrate processing apparatuses 101) installed in a particular area in every week, creates a graph, and displays the same. In the present embodiment, the sum of the total power consumption is the sum of total power consumption consumed by each of all the substrate processing apparatuses 101 installed in the particular area. Also, the total power consumption may be the sum of power consumption of the heater 207, power consumption of the vacuum pump 246, and power consumption of the controller 280, which is similar to the above described Embodiment 3. Also, total power consumption of an apparatus A, total power consumption of an apparatus B, and total power consumption of an apparatus C are separately calculated and the sum of the total power consumption of every substrate processing apparatus 101 installed in the area may be displayed in a color or the like, at every total power consumption of the substrate processing apparatus 101 as illustrated in FIG. 13A.

The processing display unit 506 calculates total heating power consumption as power consumption of a predetermined period (e.g., one week) of the apparatus A and displays the same. That is, the processing display unit 506 acquires heating power consumption information, exhaust power consumption information, and control power consumption information of the apparatus A of a predetermined period from the accumulation unit 505, calculates total power consumption of the predetermined period, creates a graph of the calculated total power consumption of the apparatus A and displays the same, as illustrated in FIG. 13B.

The processing display unit 506 calculates total exhaust power consumption as power consumption of a predetermined period (e.g., one week) of the apparatus B and displays the same. That is, the processing display unit 506 acquires heating power consumption information, exhaust power consumption information, and control power consumption information of the apparatus B of a predetermined period from the accumulation unit 505, calculates total power consumption of the predetermined period, creates a graph of the calculated total power consumption of the apparatus B and displays the same, as illustrated in FIG. 13C.

The processing display unit 506 calculates total control power consumption as power consumption of a predetermined period (e.g., one week) of the apparatus C and displays the same. That is, the processing display unit 506 acquires heating power consumption information, exhaust power consumption information, and control power consumption information of the apparatus C of a predetermined period from the accumulation unit 505, calculates total power consumption of the predetermined period, creates a graph of the calculated total power consumption of the apparatus C and displays the same, as illustrated in FIG. 13D.

Further, power consumption of the heater 207, the vacuum pump 246, and the controller 280 are separately calculated in every substrate processing apparatus 101 (apparatus A, apparatus B, and apparatus C), and in FIGS. 13B to 13D, power consumption of each of the substrate processing apparatus 101 (apparatus A, apparatus B, and apparatus C) may also be displayed in a color in each of the heater 207, the vacuum pump 246, and the controller 280.

In this manner, according to Embodiment 4, various kinds of information such as total power consumption of the substrate processing apparatus 101 is displayed by calendar week, calendar month, an calendar day, and the like, and thus, various kinds of information of the substrate processing apparatus 101 can be recognized and the information may be helpfully used for analyzing data. As a result, a state of energy saving of the substrate processing apparatus 101 can be analyzed and energy saving measure can be established, regardless of a skill of the operator.

### (Graph Comparison Example)

Further, the processing display unit 506 may calculate at least two of a total operation number of times, a total operation time, an operation rate, total power consumption, total heating power consumption, total exhaust power consumption, total control power consumption, total inert gas consumption, and total process gas consumption of the substrate processing system 100 (or the substrate processing apparatus 101) and create a graph, and display the same so as to be compared along the time axis on one screen.

That is, the processing display unit 506 may calculate at least two of the total operation number of times, the total operation time, the operation rate, the total power consumption, and the total inert gas consumption of the substrate processing system 100 (or the substrate processing apparatus 101) of a plurality of predetermined periods (e.g., one month), create a graph in every predetermined day, and display the graph to be compared along the time axis on one screen. For example, the graph indicating the total operation number of times of the substrate processing system 100 (or the substrate processing apparatus 101) of a predetermined period and the graph indicating the total operation time illustrated in FIGS. 7 and 8 may be displayed to be compared on one screen. Further, for example, the graph indicating the total power consumption of the substrate processing system 100 (or the substrate processing apparatus 101) of a predetermined period and the graph indicating the total inert gas consumption illustrated in FIGS. 10 and 11 may be displayed on one screen to be compared.

In addition, as illustrated in FIGS. 12A to 12D, the processing display unit 506 may calculate total power consumption, total heating power consumption, total exhaust power consumption, and total control power consumption of the substrate processing system 100 (or the substrate processing apparatus 101) of a plurality of predetermined periods (e.g., one day), for example, create a graph for each of a plurality of predetermined dates, and display the graphs on one screen so as to be compared.

In this case, at least two graphs among the graph indicating the total power consumption, the graph indicating the total heating power consumption, the graph indicating the total exhaust power consumption, and the graph indicating the total control power consumption of the predetermined period may be displayed on one screen so as to be compared.

In this manner, at least two graphs are displayed in parallel so as to be compared along the time axis on one screen, and thus, a state of energy saving of the substrate processing system 100 (or the substrate processing apparatus 101) can be more rapidly and accurately analyzed, regardless of a skill of the operator. As a result, a plan of energy saving measures can be easily and accurately made.

Further, the graphs illustrated in FIGS. 12A to 12D and 13A to 13D may also be configured to be displayed in the data analysis program described above.

### <Substrate Processing Apparatus (1)>

### (Vertical Processing Furnace)

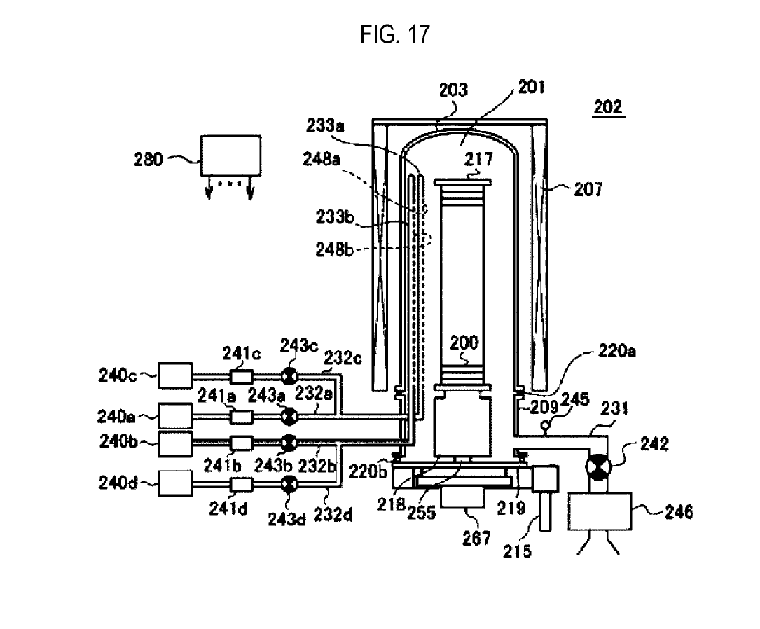

FIG. 17 is a schematic longitudinal sectional configuration view of a vertical processing furnace included in the substrate processing apparatus 101 which is appropriately used in the present embodiment.

As illustrated in FIG. 17, a processing furnace 202 includes a reaction tube 203. The reaction tube 203 is formed of a heat resistant material, and is formed to have a cylindrical shape with an upper end portion closed and a lower end portion opened. A process chamber 201 is formed in container hollow portion of the reaction tube 203, and is configured to accommodate wafers 200 as substrates in an aligned state of being horizontally oriented in a multi-storied fashion in a vertical direction by a boat 217 described later.

A manifold 209 having a concentric circle shape with the reaction tube 203 is disposed below the reaction tube 203. The manifold 209 is formed of a metal material such as, e.g., a stainless steel (SUS). The manifold 209 is formed to have a cylindrical shape with the upper and lower end portions opened. The manifold 209 is installed to support the reaction tube 203. Further, an O-ring 220a as a seal member is installed between the manifold 209 and the reaction tube 203. A reaction container is mainly formed by the reaction tube 203 and the manifold 209.

A seal cap 219 is installed below the manifold 209 as a furnace opening lid capable of tightly closing a lower end opening of the manifold 209. The seal cap 219 is formed of a metal such as, e.g., stainless steel, and has a disk shape. An O-ring 220b is installed as a seal member between the seal cap 219 and the manifold 209.

### (Substrate Support)

A boat 217 as a substrate support is erected on the seal cap 219 with an insulator 218 formed of, e.g., a quartz cap interposed therebetween. The boat 217 is formed of a heat resistant material such as, e.g., quartz or silicon carbide, and configured to support a plurality of wafers 200 in a horizontal posture and at multiple stages by arranging the wafers 200 in a tube axis direction with the centers of the wafers 200 aligned with one another, as described above.

A rotary mechanism 267 for rotating the boat 217 is installed on the side of the seal cap 219 opposite to the process chamber 201. A rotary shaft 255 of the rotary mechanism 254 is connected to the boat 217 through the seal cap 219, and configured to rotate the boat 217 to thereby rotate the wafer 200. The seal cap 219 is configured to be lifted and lowered in a vertical direction by a boat elevator 115 as a lifting mechanism installed outside of the reaction tube 203, whereby the boat 217 may be loaded into or unloaded from the process chamber 201.

### (Heating Unit)

A heater 207 as a heating means (heating mechanism) for heating the interior of the process chamber 201 is installed on an outer side of the reaction tube 203 to have a concentric circle shape surrounding a sidewall surface of the reaction tube 203. The heater 207 is formed to have a cylindrical shape. The heater 207 is supported by a heater base as a support plate so as to be installed vertically.

A temperature sensor is installed as a temperature detector within the reaction tube 203. A controller 280 described later is electrically connected to the heater 207 and the temperature sensor. The controller 280 is configured to control supply of power to the heater 207 based on temperature information detected by the temperature sensor at a predetermined timing such that an internal temperature of the process chamber 201 has a predetermined temperature distribution.

### (Gas Supply System)

A first nozzle 233a as a first gas introduction part and a second nozzle 233b as a second gas introduction part are installed in the manifold 209 to pass through the manifold 209. A first gas supply pipe 232a is connected to the first nozzle 233a and a second gas supply pipe 232b is connected to the second nozzle 233b. In this manner, the two nozzles 233a and 233b and the two gas supply pipes 232a and 232b are connected to the manifold 209, and it is configured such that a plurality of types of, here, at least two types of process gases can be supplied into the process chamber 201.

The controller 280 described later is electrically connected to mass flow controllers (MFCs) 241a to 241d and valves 243a to 243d. The controller 280 is configured to control the MFCs 241a to 241d such that a flow rate of gas supplied into the process chamber 201 has a predetermined flow rate at a predetermined timing.

A first gas supply system is mainly configured by the first gas supply pipe 232a, the MFC 241a, the valve 243a and the first nozzle 233a. Also, it may be considered that a first gas supply source 240a is included in the first gas supply system. Further, a second gas supply system is mainly configured by the second gas supply pipe 232b, the MFC 241b, the valve 243b and the second nozzle 233b. Also, it may be considered that a second gas supply source 240b is included in the second gas supply system. The process gas supply system according to the present embodiment is configured by the first gas supply system and the second gas supply system.

A first inert gas supply system is mainly configured by a first inert gas supply pipe 232c, the MFC 241c, and the valve 243c. Also, it may be considered that a first inert gas supply source 240c or the first gas nozzle 233a is included in the first inert gas supply system. Further, a second inert gas supply system is mainly configured by a second inert gas supply pipe 232d, the MFC 241d, and the valve 243d. Also, it may be considered that a second inert gas supply source 240d or the second gas nozzle 233b is included in the second inert gas supply system. The inert gas supply system according to the present embodiment is configured by the first inert gas supply system and the second inert gas supply system.

The gas supply systems according to the present embodiment are configured by the first gas supply system, the second gas supply system, the first inert gas supply system and the second inert gas supply system.

A gas containing, e.g., a silicon element (Si) (silicon-containing gas) as a precursor gas is supplied into the process chamber 201 from the first gas supply pipe 232a through the MFC 241a, the valve 243a, and the first nozzle 233a. As the silicon-containing gas, e.g., a dichlorosilane (SiH₂Cl₂), abbreviation: DCS) gas may be used.

A gas containing, e.g., a nitrogen element (N) (nitrogen-containing gas) as a reaction gas is supplied into the process chamber 201 from the second gas supply pipe 232b through the MFC 241c, the valve 243c, and the second nozzle 233b. As the nitrogen-containing gas, for example, an ammonia (NH₃) gas may be used.

An inert gas is supplied into the process chamber 201 from each of the first inert gas supply pipe 232c and the second inert gas supply pipe 232d through the MFCs 241c and 241d, the valves 243c and 243d, the first gas supply pipe 232a, the second gas supply pipe 232b, the first nozzle 233a, and the second nozzle 233b. As the inert gas, for example, the group 18 elements such as a helium (He) gas, a neon (Ne) gas and an argon (Ar) gas, or N₂ may be used.

### (Exhaust Unit)

An exhaust pipe 231 is installed on a sidewall of the manifold 209 to evacuate air from the interior of the process chamber 201. A pressure sensor 245 as a pressure detector (pressure detecting unit) for detecting an internal pressure of the process chamber 201, an auto pressure controller (APC) valve 242 as a pressure regulator (pressure regulating unit), and a vacuum pump 246 as an exhaust device are installed in the exhaust pipe 231 in this order from the upper stream side.

The controller 280 described later is electrically connected to the pressure sensor 245 and the APC valve 242. The controller 280 is configured to control the APC valve 242 based on pressure information detected by the pressure sensor 245 such that the internal pressure of the process chamber 201 has predetermined pressure (degree of vacuum). An exhaust system is mainly configured by the exhaust pipe 231, the AFC valve 242 and the pressure sensor 245. Also, it may be considered that the vacuum pump 246 is included in the exhaust system.

### (Control Unit)

The controller 280 as a control unit (control means) is connected to the MFCs 241a to 241d, the valves 243a to 243d, the pressure sensor 245, the APC value 242, the vacuum pump 246, the heater 207, the temperature sensor, the rotary mechanism 267, the boat elevator 215, and the like. A flow adjusting operation of various gases by the MFCs 241a to 241d, an opening and closing operation of the valves 243a to 243d, a pressure regulating operation based on opening and closing of the APC valve 242 and the pressure sensor 245, a pressure adjusting operation based on the pressure sensor 245, a temperature adjusting operation of the heater 207 based on the temperature sensor, actuation and stopping of the vacuum pump 246, a rotational speed adjusting operation of the rotary mechanism 267, a lifting and lowering operation of the boat elevator 215, and the like are controlled by the controller 280.

### (5) Substrate Processing Process

Next, a substrate processing process as a process of manufacturing a semiconductor device by using the vertical processing furnace 202 of the substrate processing system 100 described above is described. For example, an example of a process of forming a silicon nitride (SiN) film on the wafer 200 as a substrate is described with reference to FIG. 17. Also, in the following descriptions, the operation of each of the components that constitute the substrate processing system 100 is controlled by the controller 280.

Further, in the present embodiment, for example, a DCS gas containing silicon as a precursor gas and an NH₃ gas containing nitrogen as a reaction gas are supplied into the heated process chamber 201, and an SiN film is formed on the wafer 200 through a chemical vapor deposition (CVD) method.

### (Substrate Loading Process)

First of all, a plurality of wafers 200 are charged in the boat 217 (wafer charging). Then, as illustrated in FIG. 17, the boat 217 that sustains the wafers 200 are lifted by the boat elevator 215 and loaded into the process chamber 201 (boat loading). In this state, the seal cap 219 seals the lower end portion of the manifold 209 by the medium of the O-ring 220b.

### (Process of Adjusting Pressure Temperature)

The interior of the process chamber 201 is evacuated by the vacuum pump 246 to have a desired pressure (vacuum degree). At this time, an internal pressure of the process chamber 201 is measured by the pressure sensor 245, and a degree of opening of the APC valve 242 is feedback-controlled based on the measured pressure (pressure adjustment). Further, the interior of the process chamber 201 is heated by the heater 207 to have a desired temperature. At this time, in order for the interior of the process chamber 201 to have a desired temperature distribution, specifically, in order for the process chamber 201 to have a temperature distribution allowing for a CVD reaction, supply power to the heater 207 is feedback-controlled based on temperature information detected by the temperature sensor (temperature adjustment). Subsequently, the boat 217, i.e., the wafer 200, starts to be rotated by the rotary mechanism 267. The pressure adjustment, temperature adjustment, and rotation of the wafer 200 are continued until at least a film forming process described later is terminated.

### (Film Forming Process)

Subsequently, an NH₃ gas as a reaction gas is supplied into the process chamber 201. Specifically, the valve 243b installed in the second gas supply pipe 232b is opened. Accordingly, the NH₃ gas supplied from the gas source 242b starts to be supplied into the process chamber 201 with the second nozzle 231b interposed therebetween, while adjusting a flow rate by the MFC 241b. Simultaneously, at least one of the valve 243c installed in the first inert gas supply pipe 232c and the valve 243d installed in the second inert gas supply pipe 232d is opened, and an Ar gas, which is an inert gas as a dilution gas or a carrier gas, may be supplied into the process chamber 201.

Subsequently, a DCS gas as a precursor gas is supplied into the process chamber 201 filled with the NH₃ gas. Specifically, the valve 243a installed in the first gas supply pipe 232a is opened, and the DCS gas supplied from the first gas source 242a starts to be supplied into the process chamber 201 with the first nozzle 231a interposed therebetween. Simultaneously, at least any one of the valve 243c installed in the first inert gas supply pipe 232c and the valve 243d installed in the second inert gas supply pipe 232d is opened, and an Ar gas, which is an inert gas as a dilution gas or a carrier gas, may be supplied into the process chamber 201.

The DCS gas supplied into the process chamber 201 filled with the NH3 gas is diluted and diffused by the N₂ gas and brought into contact with the surface of the wafer 200 heated when passing through the interior of the process chamber 201. As a result, an SiN film is deposited on the wafer 200.

After a predetermined period of time has lapsed, when the SiN film has a predetermined film thickness, the valve 243a is closed and the supply of the DCS gas into the process chamber 201 is stopped. Thereafter, the valve 243b is closed and the supply of the NH3 gas into the process chamber 201 is stopped.

### (Purge Process)

After the supply of the DCS gas and the NH₃ gas into the process chamber 201 is stopped, at least any one of the valve 243c and the valve 243d is left open, and the supply of the Ar gas into the process chamber 201 is continued. Thus, the interior of the process chamber 201 is purged by the Ar gas and a residual gas or a reaction product that remains within the process chamber 201 are removed.

### (Process of Returning to Atmospheric Pressure and Unloading Substrate)

When purging is completed, power supply to the heater 207 is stopped to decrease the internal temperature of the process chamber 20, and the degree of opening the APC valve 242 is adjusted to return the internal pressure of the process chamber 201 to an atmospheric pressure. Thereafter, the boat 217 is unloaded from the interior of the process chamber 201 (boat unloading) in reverse order of the order illustrated in the substrate loading process described above, and the wafer 200 with an SiN film having a predetermined thickness formed thereon is discharged from the boat 217 (wafer discharging), and the substrate processing process according to the present embodiment is terminated.

### (6) Configuration of Other Substrate Processing Apparatus

### <Substrate Processing Apparatus (2)>

### (Sheet Process Chamber)

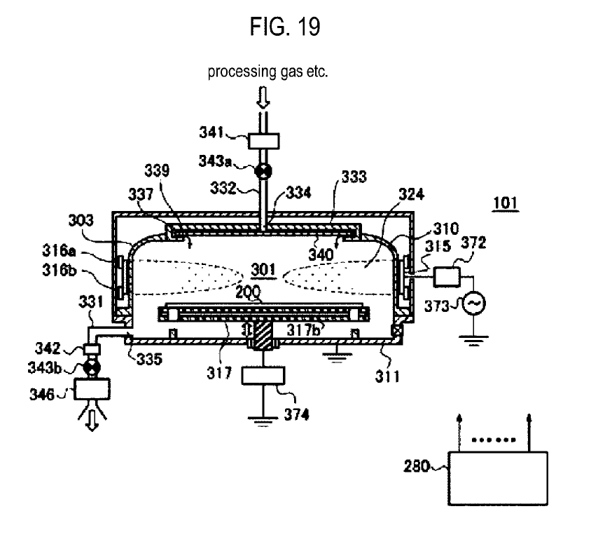

FIG. 19 is a schematic longitudinal sectional view of an MMT device as a process chamber of a sheet-type device appropriately used in the present embodiment. The MMT device is a device which employs a modified magnetron typed plasma source that may generate high-density plasma by an electric field and a magnetic field, and plasma-processes the wafer 200 as a substrate.

As illustrated in FIG. 19, a process container 303 that forms a process chamber 301 includes a dome-shaped upper container 310 as a first container and a bowl-type lower container 311 as a second container.

A susceptor 317 that supports the wafer 200 is disposed in the center of a bottom side within the process chamber 301. The susceptor 317 is formed of a nonmetal material to reduce metal contamination of the wafer 200.

A heater 317b as a heating mechanism is integrally embedded within the susceptor 317 such that it can heat the wafer 200. When power is supplied to the heater 317b, a surface of the wafer 200 is heated to a predetermined temperature (e.g., room temperature to 1000 degrees C.). Further, a temperature sensor is installed in the susceptor 317. The controller 280 as described above is electrically connected to the heater 317b and the temperature sensor. The controller 280 is configured to control supply of power to the heater 317b based on temperature information detected by the temperature sensor at a predetermined timing.

In addition, an electrode for changing impedance is installed within the susceptor 317. The electrode is installed by the medium of an impedance variable mechanism 374. The impedance variable mechanism 374 includes a coil or a variable condenser, and by controlling the number of patterns of the coil or a capacitance value of the variable condenser, the impedance variable mechanism 374 may control a potential of the wafer 200 by the medium of the electrode and the susceptor 317. Further, the foregoing controller 280 is electrically connected to the impedance variable mechanism 374.

A lid 333 is airtightly installed in an opening formed in an upper portion of the upper container 310. A shielding plate 340 is installed below the lid 333. A space between the lid 333 and the shielding plate 340 is a buffer chamber 337. The buffer chamber 337 serves as a distribution space configured to distribute a process gas introduced from a gas introduction portion 334. Then, a process gas that passes through the buffer chamber 337 is supplied from a side gas discharge hole 339 of the shielding plate 340 into the process chamber 301.

A gas supply pipe 332 is connected to the gas introduction portion 334. A gas source for supplying a process gas or an inert gas, an MFC 341 as a flow control device, and a valve 343a as an opening and closing valve are installed in the gas supply pipe 332 in this order from an upstream side. The foregoing controller 280 is electrically connected to the MFC 341 and the valve 343a. The controller 280 is configured to control opening and closing of the valve 343a and the MFC 341 such that a flow rate of gas supplied into the process chamber 301 is a predetermined flow rate. In this manner, it is configured such that, by opening and closing the valve 343a, a process gas or an inert gas may be freely supplied into the process chamber 301 by the medium of the gas supply pipe 332, the buffer chamber 337, and the gas discharge hole 339, while controlling a flow rate by the MFC 341. A gas supply unit according to the present embodiment is mainly configured by the gas supply pipe 332, the MFC 341, and the valve 343a. Also, it may be considered that the gas supply source is included in the gas supply unit according to the present embodiment.

A gas exhaust port 335 for exhausting a process gas or the like from the interior of the process chamber 301 is installed in a lower portion of a sidewall of the lower container 311. An upstream end of the gas exhaust pipe 331 for exhausting a gas is connected to the gas exhaust port 335. An APC 342 as a pressure adjuster, a valve 343b as an opening and closing valve, and a vacuum pump 346 as an exhaust device are installed in the gas exhaust pipe 331 in this order from an upstream. The foregoing controller 280 is electrically connected to the APC 342, the valve 343b, and the vacuum pump 346. It is configured such that, by opening the valve 343b by operating the vacuum pump 346, the interior of the process chamber 301 can be exhausted. Also, it is configured such that, by adjusting a degree of opening of the APC 342, an internal pressure value of the process chamber 301 can be adjusted.

On an outer circumference of the process container 303 (upper container 310), a container-shaped electrode 315 is installed to surround a plasma generation region 324 within the process chamber 301. The container-shaped electrode 315 is formed to have a container shape, e.g., a cylindrical shape. The container-shaped electrode 315 is connected to a high-frequency power 373 that generates a high-frequency power with a matching unit 372 which performs impedance matching interposed therebetween. The container-shaped electrode 315 serves as a discharge mechanism that plasma-excites a process gas supplied into the process chamber 301.

After at least a process gas is supplied into the process chamber 301, a high-frequency power is supplied to the container-shaped electrode 315 to form an electric field, and a magnetic field is formed by using an upper magnet 316a and a lower magnet 316b, thus generating a magnetron discharge plasma in a plasma generation region 324 within the process chamber 301. At this time, as the foregoing electromagnetic field circulates emitted electrons, an ionization generation rate of plasma can be increased and a high-density plasma having long lifespan can be generated.

Further, the substrate processing process performed by using a sheet process chamber regarding the present embodiment has at least a substrate loading process, a substrate processing process, and a substrate unloading process. That is, the substrate processing process performed by using the vertical processing furnace as described above, for example, the substrate processing process includes a substrate loading process, a pressure temperature adjusting process, a treating process, a purge process, and an atmospheric pressure returning substrate unloading process.

According to the present embodiment, one or a plurality of effects can be obtained as follows.

(a) According to the present embodiment, there is provided a management device 500 including an accumulation unit 505 configured to acquire at least any one of power consumption information about power consumed in the substrate processing apparatus 101 that processes a substrate, gas consumption information about gas consumed in the substrate processing apparatus 101, and operation information about an operation state of the substrate processing apparatus 101 and accumulating the same such that it can be read, and a processing display unit 506 configured to acquire information that meets a predetermined condition from the accumulation unit 505, calculate at least any one of power consumption and inert gas consumption consumed by the substrate processing apparatus 101, and an operation rate of the substrate processing apparatus 101, and display the same on a display unit 508. Thus, a state of energy saving of each substrate processing apparatus 101 installed in the overall semiconductor manufacturing factory (or the overall particular area) can be rapidly and accurately analyzed at low cost, regardless of a skill of the operator. Accordingly, it is easy to establish energy saving measures of the substrate processing apparatus 101 or analyze the generation of an abnormal phenomenon of the substrate processing apparatus 101. That is, a plan of energy saving measures of the substrate processing apparatus 101 can be easily made. Further, it may be helpful as a tool that assists a thought of the operator, such as recognition of a problem of the substrate processing apparatus 101, recognition of a sign of failure of the substrate processing apparatus 101, detection of a problem of a recipe, and the like.

(b) According to the present embodiment, the accumulation unit 505 is configured to accumulate apparatus-specific information that specifies the substrate processing apparatus 101 in operation, operation time information that specifies an operation start time and an operation stop time of the substrate processing apparatus 101, and recipe-specific information that specifies a recipe for substrate processing executed by the substrate processing apparatus 101, as operation information indicating an operational situation of the substrate processing apparatus 101. Then, by acquiring at least any one of the apparatus-specific information, the operation time information, and the recipe specific information from the accumulation unit 505, the processing display unit 506 is configured to calculate a total operation number of times of a predetermined period of the substrate processing apparatus 101, a total operation time of the substrate processing apparatus 101 within the predetermined period, and an operation rate of the substrate processing apparatus 101 within the predetermined period, and display the same. Thus, the operation rate, an operation state, and the like of the substrate processing apparatus 101 can be rapidly and accurately analyzed to be recognized, regardless of a skill of the operator. Accordingly, it is easy to establish energy saving measures of the substrate processing apparatus 101. Further, when a plan of the energy saving measures is made, it may also be helpful as a tool that assists a thought of the operator.

(c) According to the present embodiment, the accumulation unit 505 is configured to accumulate apparatus power consumption information of the substrate processing apparatus 101 and power consumption time information that specifies power consumption start time and power consumption stop time of the substrate processing apparatus 101, as power consumption information indicating a power consumption situation of the substrate processing apparatus 101. Then, by acquiring the apparatus power consumption information and the power consumption time information from the accumulation unit 505, the processing display unit 506 is configured to calculate total power consumption of a predetermined period of the substrate processing apparatus 101 and display the same. Thus, total power consumption of the substrate processing apparatus 101 can be rapidly or accurately analyzed to be recognized regardless of a skill of the operator, and it may be helpful to establish energy saving measures. In addition, since power consumption is reduced, the generation of greenhouse gas can be reduced.

(d) According to the present embodiment, the accumulation unit 505 is configured to accumulate inert gas consumption information and inert gas consumption time information that specifies an inert gas consumption start time and an inert gas consumption stop time supplied from auxiliary equipment of a gas supply system, as gas consumption information indicating a gas consumption situation of the substrate processing apparatus 101. Then, by acquiring the inert gas consumption information and the inert gas consumption time information from the accumulation unit 50, the processing display unit 506 is configured to calculate total inert gas consumption of a predetermined period of the substrate processing apparatus 101 and display the same. Thus, consumption of an inert gas which is greatly consumed can be rapidly and accurately analyzed to be recognized regardless of a skill of the operator and it may be helpful to establish energy saving measures.

(e) According to the present embodiment, the substrate processing apparatus 101 includes a heater 207 for heating the wafer 200, and the accumulation unit 505 is configured to accumulate heating power consumption information as power consumption of the heater 207 and heating time information that specifies a power consumption start time and a power consumption stop time of the heater 207. Then, by acquiring the heating power consumption information and the heating time information from the accumulation unit 505, the processing display unit 506 is configured to calculate total heating power consumption of the predetermined period of the heater 207 and display the same. Thus, in the substrate processing apparatus 101, in particular, power consumption of the heater 207, which consumes a large amount of power, can be rapidly and accurately analyzed to be recognized regardless of a skill of the operator and it may be helpful to establish energy saving measures.

(f) According to the present embodiment, a vacuum pump 246 as auxiliary equipment of a gas exhaust system that exhausts the interior of the process chamber 201 which processes the wafer 200 is provided, and the accumulation unit 505 is configured to accumulate exhaust power consumption information as power consumption of the vacuum pump 246 and exhaust time information that specifies a power consumption start time and a power consumption stop time of the vacuum pump 246. Then, by acquiring the exhaust power consumption information and the exhaust time information from the accumulation unit 505, the processing display unit 506 is configured to calculate total exhaust power consumption of a predetermined period of the vacuum pump 246 and display the same. Thus, in the substrate processing apparatus 101, power consumption of the vacuum pump 246, which consumes a large amount of power, can be rapidly and accurately analyzed to be recognized regardless of a skill of the operator and it may be helpful to establish energy saving measures.

(g) According to the present embodiment, the substrate processing apparatus 101 includes the controller 280 that controls at least the heater 207 and the vacuum pump 246, and the accumulation unit 505 is configured to accumulate control power consumption information as power consumption of the controller 280 and control time information that specifies a power consumption start time and a power consumption stop time of the controller 280. Then, by acquiring the control power consumption information and the control time information from the accumulation unit 505, the processing display unit 506 is configured to calculate total control power consumption of a predetermined period of the controller 280 and display the same. Thus, in the substrate processing apparatus 101, power consumption of the controller 280, which consumes a large amount of power, can be rapidly and accurately analyzed to be recognized regardless of a skill of the operator and it may be helpful to establish energy saving measures.

(h) According to the present embodiment, the processing display unit 506 is configured to create a graph of the total operation number of times, the total operation time, the operation rate, the total power consumption, the total heating power consumption, the total exhaust power consumption, the total control power consumption, and the total inert gas consumption described above, and display the same. Thus, visibility can be enhanced and the operator can more rapidly and accurately analyze a state of the substrate processing apparatus 101 and easily find out a problem or fault of the substrate processing apparatus 101.

(i) According to the present embodiment, the processing display unit 506 is configured to create graphs of at least two of the total operation number of times, the total operation time, the operation rate, the total power consumption, the total heating power consumption, the total exhaust power consumption, the total control power consumption, and the total inert gas consumption described above, and display the graphs such that they are compared along a time axis on one screen. Thus, visibility can be enhanced and the operator can more rapidly and accurately analyze a state of the substrate processing apparatus 101 and easily find out a problem or fault of the substrate processing apparatus 101.

For example, the graph of the operation rate illustrated in FIG. 9, the graph of the total power consumption or the like illustrated in FIGS. 10 and 12A to 12D, and the graph of the total inert gas consumption illustrated in FIG. 11 are displayed to be compared along the time axis on one screen, and thus, a problem or a fault of the substrate processing apparatus 101 can be more easily discovered regardless of a skill of the operator. That is, for example, whether the total power consumption and the total inert gas consumption also increase depending on an increase in the operation rate of the substrate processing apparatus 101 can be checked as to whether there is a relevance considered by the operator, whereby the state of the substrate processing apparatus 101 can be rapidly and accurately recognized regardless of a skill of the operator. Furthermore, for example, when the energy saving measures (for example, a set value of an inert gas for purge is reduced to reduce a standby power by lowering a set temperature of the heater 207 till execution of a next recipe, after a recipe is terminated, etc.) are established in the substrate processing apparatus 101, a month prior to the measures and a month after the measures are compared, and, even though the operation rate of the substrate processing apparatus 101 is not changed, it can be rapidly and accurately determined that the effect of the energy saving measures is exerted by checking a reduction in the total power consumption or the total inert gas consumption, regardless of a skill of the operator. Moreover, for example, by integrating individual data such as the operation rate, the total power consumption, and the total inert gas consumption of the individual substrate processing system 100 and providing information to the operator, for example, it can be used as an auxiliary tool when planning energy saving measures of the overall factory, and the effect of the energy saving measures can be more easily exerted.

In addition, for example, as illustrated in FIG. 15, by displaying the graph of the total power consumption and the graph of the total inert gas consumption of a predetermined period such that they can be compared along the time axis for every recipe type executed by the substrate processing apparatus 101 on one time, it is easy to discover a problem, a fault, or the like of the substrate processing apparatus 101 regardless of a skill of the operator. That is, for example, it may be a clue for analyzing whether the substrate processing apparatus 101 does not have an error, whether a recipe has been changed, whether sequence execution of the recipe does not have an error, or the like. Further, by comparing the total power consumption and the total inert gas consumption in every recipe type, total power consumption and total inert gas consumption depending on recipe types can be checked and it is easy to perform energy saving measures. Specifically, for example, as illustrated in FIG. 15, in recipe A executed within a predetermined period by the substrate processing apparatus 101, even in case of the execution number of times (No. 2 to No. 7) determined to be normal in recipe termination situation, when the execution numbers No. 2 to No. 5 and the execution numbers No. 6 and No. 7 are compared, it can be seen that the total power consumption of the execution numbers No. 6 and No. 7 is greater than the execution numbers No. 2 to No. 5. Thus, with the execution numbers No. 6 and No. 7, it can be easily analyzed that the substrate processing apparatus 101 has an error. Further, for example, in FIG. 15, it can be seen that the total power consumption and the total inert gas consumption are greater in recipe A than recipe B. However, when the operator considers that the total power consumption and the total inert gas consumption will be greater in recipe B than in recipe A, the executed recipe becomes different (erroneous), and thus, the sequence execution of a recipe has an error and the substrate processing apparatus 101 has an error, and in this case, the generation of a problem or an error in the substrate processing apparatus 101 can be easily analyzed.

Moreover, for example, as illustrated in FIG. 16, by displaying the graph indicating an operation state of the substrate processing apparatus 101 and the graph of the total power consumption to be compared on one screen along the time axis, a problem, an error, or the like of the substrate processing apparatus 101 can be easily discovered, regardless of a skill of the operator. That is, for example, the shape of the graph of the power consumption rate of recipe A executed one time and two times and the shape of the graph of the power consumption of recipe A executed five times are different although the same recipe was executed. Thus, it can be easily analyzed that an error has occurred in recipe A executed five times. Further, for example, the problem of the substrate processing apparatus 101, that energy saving can be sought by lowering a standby power of the substrate processing apparatus 101 until execution of recipe A of two times is started after termination of execution of recipe A of first time, can be also found out. In addition, for example, the problem of the substrate processing apparatus 101, that, when the substrate processing apparatus 101 starts to be operated, namely, when a recipe starts to be executed, for example, power consumption is increased as a temperature of the heater 207 is increased and a load of the substrate processing apparatus 101 is increased, can be found out.

Further, for example, the processing display unit 506 may calculate a load rate of the substrate processing apparatus 101 and display the same. In general, when a high load rate of the substrate processing apparatus 101 continues for a long period of time, a breaker falls and co nsumption of the substrate processing apparatus 101 becomes early. Thus, by analyzing a load rate of the substrate processing apparatus 101, measures that can help to make a plan of updating the substrate processing apparatus 101, review a breaker, and review a power line can be taken.

Further, in the embodiment described above, at least two graphs are displayed to be compared on one screen, but for example, the operation rate or the total power consumption may be indicated as numerical values and displayed to be compared on one screen.

Additionally, in the embodiment described above, the accumulation unit 505 accumulates acquired information in a table form, but the present disclosure is not limited thereto and the obtained information may be accumulated to be readable by the accumulation unit 505.

Moreover, in the embodiment described above, the accumulation unit 505 acquires information from the substrate processing apparatus 101 through the memory 502, but the present disclosure is not limited thereto, and for example, the accumulation unit 505 may be configured to obtain information directly from the substrate processing apparatus 101.

Further, in the embodiment described above, the accumulation unit 505 accumulate average vales of each consumption of a predetermined interval of data acquisition, as the apparatus power consumption information, the heating power consumption information, the exhaust power consumption information, the control power consumption information, the inert gas consumption information, and the like, and the processing display unit 506 calculates total power consumption, or the like on the basis of each information of the average value and displays the same, but the present disclosure is not limited thereto. For example, the accumulation unit 505 may accumulate a maximum value or a minimum value of each consumption of the predetermined interval of data acquisition, as the apparatus power consumption information, the inert gas consumption information, and the like, and the processing display unit 506 may calculate the total power consumption, or the like on the basis of each information of the maximum value or the minimum value, and display the same.

Further, in the embodiment described above, the group management device 102 is installed in every substrate processing apparatus 101, but the group management device 102 may be shared by the plurality of substrate processing apparatuses 101 as described later.

In addition, in the embodiment described above, the network connection-type power sensor and the inert gas consumption sensor are installed to automate collection of data required for planning energy saving measures and accumulate the same in the accumulation unit. Thus, the operation is finished without causing a trouble such as information aggregate. Also, similarly, a flow rate sensor may also be installed in cooling water, and data may be collected.

### Other Embodiments of the Present Disclosure

While the embodiment of the present disclosure has been described in detail above, the present disclosure is not limited to the embodiment described above and may be variously modified without departing from the spirit and scope of the present disclosure.

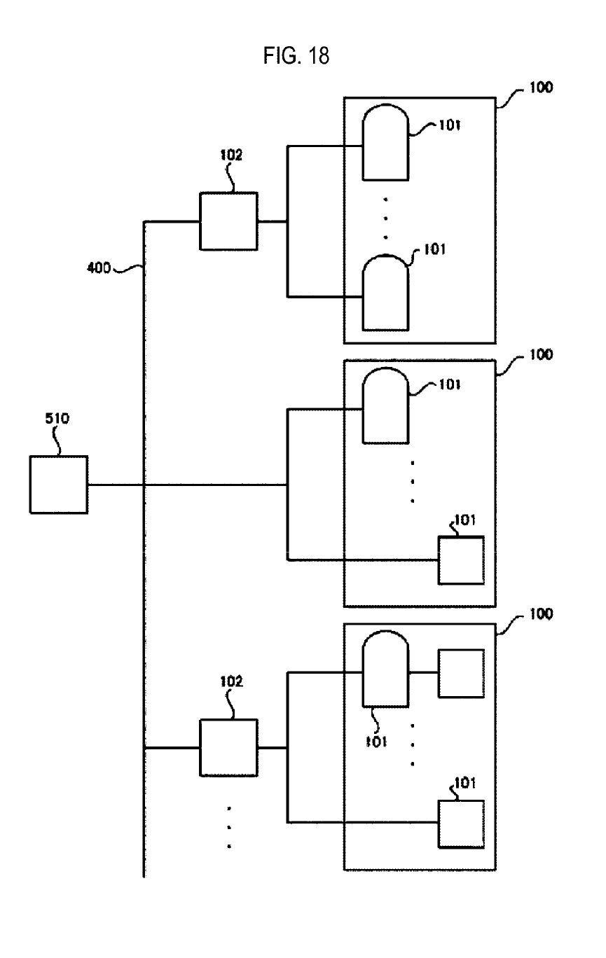

For example, as illustrated in FIG. 18, three layers of the substrate processing system 100, a monitor server 102 as a group management device, which is a computer system that provides information from one or a plurality of substrate processing apparatuses 101 to the operator, and a management device (e.g., host computer) 510 as an integrated management device, which is a computer system that provides information from the one or a plurality of monitor servers 102 to the operator may be configured. Specifically, for example, the monitor server 102 may be installed in every predetermined area, one or a plurality of substrate processing systems 100 that belong to a predetermined area is integrally managed, and the management device 510 may integrally manage one or a plurality of substrate processing systems 100 in the overall factory. Further, the substrate processing system 100, the monitor server 120, and the management device 510 are connected through a network 400 such as a LAN. Also, as illustrated, as the substrate processing system 100, a single-wafer-type device, a vertical device, and the like may coexist. Additionally, the substrate processing system 100 may include auxiliary equipment.

Here, when an information provision program that includes a data accumulation program and a data analysis program is installed in the management device 510, the monitor server 102 or the substrate processing system 100 may need to perform a remote log-in to the management device 510. When the log-in is normally terminated, it is configured such that the data analysis program may be executed. When the monitor server 102 or the substrate processing system 100 fails to log in, the management device 510 is configured not to execute the data analysis program. In this case, the accumulation unit 505 as a database is installed in the management device 510.

When the data analysis program is installed in the monitor server 102, the substrate processing system 100 is configured to execute the data analysis program by performing remote log-in to the monitor server 102 which is connected thereto. For example, when log-in of the substrate processing system 100 (or the substrate processing apparatus 101) connected to the monitor server 102 fails, it is configured such that the data analysis program cannot be executed in the monitor server 102. This is because, if a leakage of data regarding energy saving consumed in the substrate processing system 100 (or the substrate processing apparatus 101) connected to the monitor server 102 occurs, it is impossible to accurately analyze the data. However, the data analysis program may be executed even though every substrate processing system 100 (or substrate processing apparatus 101) fails to log in. Also, in this case, the accumulation unit 505 is installed in the monitor server 102.

When the data analysis program is installed in the controller 280 of the substrate processing system 100 the management device 510 or the monitor server 102 is configured to refer to the result of execution of the data analysis program by performing remote log-in to the substrate processing system 100. At this time, the accumulation unit 505 is installed in the substrate processing system 100.

Further, the management device 510 may execute the data analysis program of the overall factory, for example, and the monitor server 102 may execute the data analysis program of a predetermined area, for example, and the substrate processing system 100 may execute the data analysis program of the substrate processing system 100. At this time, required information may be downloaded from the management device 510 to the monitor server 102 or the substrate processing system 100 or from the monitor server 102 to the substrate processing system 100. Also, required information may be uploaded from the substrate processing system 100 to the monitor server 102 or the management device 510 or from the monitor server 102 to the management device 510. In this case, the accumulation unit 505 may be installed in each of the management device 510, the monitor server 102, and the controller 280 of the substrate processing system 100.

### Another Embodiment of the Present Disclosure

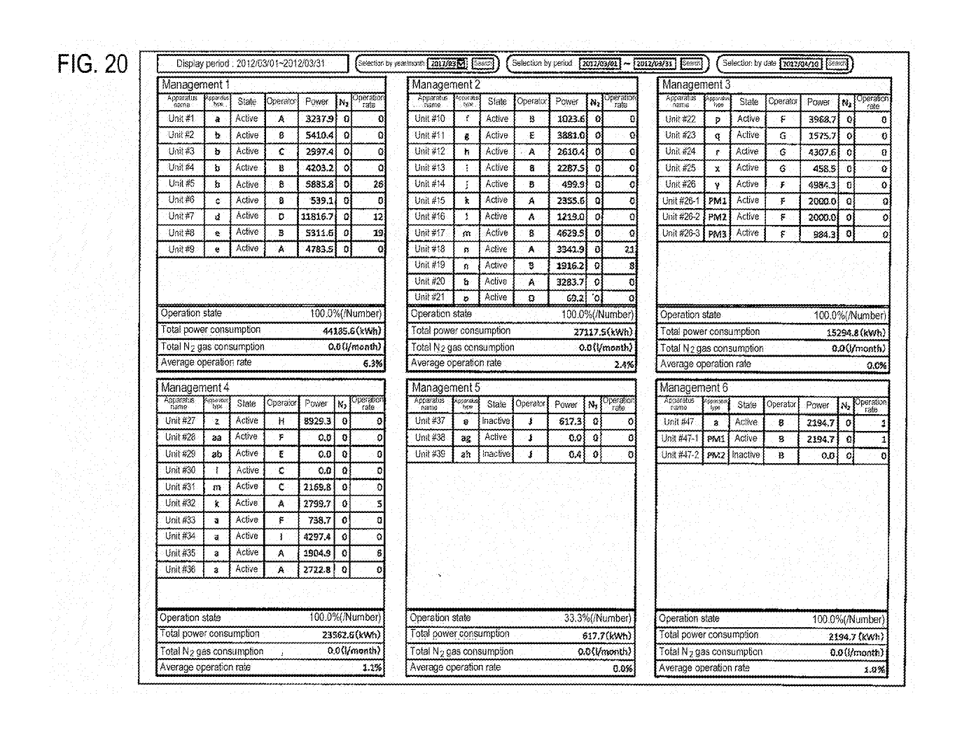

FIG. 20 is a view illustrating an example of an overview screen in an integrated management system including three layers of the substrate processing system 100, the monitor server 102 as a group management device, which is a computer system that provides information from one or a plurality of substrate processing apparatuses 101 to the operator, and a management device (e.g., a host computer) 500 as an integrated management device, which is a computer system that provides information from one or a plurality of monitor servers 102 to the operator.

The overview screen illustrated in FIG. 20 and the overview screen illustrated in FIG. 6 are different in whether to display information as an indicator of energy saving regarding the group of the substrate processing apparatuses 101 disposed in each area or whether to display information as an indicator of energy saving in every substrate processing apparatus 101 connected to the group management device 102, and contents of other items are the same.

Also, in another embodiment described above, various kinds of information such as an apparatus operation rate, power consumption, and inert gas consumption of each substrate processing apparatus 101 may be displayed on the screen, and thus, various kinds of information indicating a state of energy saving in each substrate processing apparatus 101 connected to the group management device 102, a film thicknesses measuring instrument, or the like may be collectively recognized. Further, by recognizing a detailed state of energy saving of individual substrate processing apparatus 101 or the like connected to the group management device 102, data may be analyzed by using the information, thus contributing to energy saving measures. For example, since the apparatus operation rate is low, energy saving measures such that every substrate processing apparatus 101 is connected to the single group management device 102 and degeneration operation is performed may be performed. Thus, energy saving effect can be anticipated.

Moreover, the present disclosure is not limited to a case in which the substrate processing apparatus 101 and the group management device 102 are disposed in the same floor (in the same clean room). For example, the substrate processing apparatus 101 may be disposed in the clean room, the group management device 102 may be disposed in an office (in a floor different from the clean room), and a progress situation of recipe or a state of the substrate processing apparatus 101 may be remotely monitored and analyzed through the network 400 such as a LAN. Alternatively, some components of the management device 500, for example, only the display unit 508, may be disposed in the office.

### Modification of the Present Disclosure

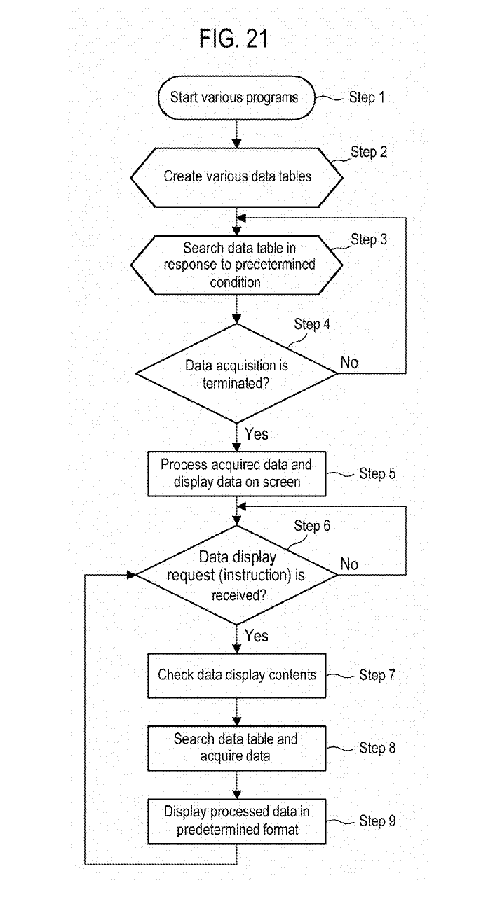

FIG. 21 is a view illustrating a modification of a flow to execute an information provision program. FIG. 21 provides an example of a flow that displays an overview screen illustrated in FIG. 6, rather than a command screen illustrated in FIG. 3, after starting the information provision program. Further, step 1 and step 2 are the same contents as those of FIG. 5, and thus, a description thereof will be omitted, and a process starting from step 3 is described hereinafter.

Step 3 is a process of searching a data table depending on a preset predetermined condition and acquiring desired data, and step 4 is a process of determining termination of data acquisition. Step 3 and step 4 are data obtaining processes. Specifically, in step 3, a data table is searched based on display period data indicating a data acquisition period and display range data indicating a range of a data acquisition target which are set under a predetermined condition, and a measurement value of utility data, for example, at least information related to an apparatus operation rate of the substrate processing apparatus 101 such as power consumption consumed by the substrate processing apparatus 101, inert gas consumption, recipe-specific information, operation information are acquired. For example, in case of operation information, an operation start time and an operation termination time in a display period are repeatedly obtained. Step 4 is repeatedly performed until it is determined that obtaining of every data is terminated. Then, when it is determined that every data has been obtained in step 4, the flow proceeds to step 5.

Step 5 is a data processing process of processing acquired data and displaying a screen. Specifically, based on information obtained in the data obtaining processes (step 3 and step 4) (e.g., power consumption consumed in the substrate processing apparatus 101, inert gas consumption, and information related to an apparatus operation rate of the substrate processing apparatus 101) by the data processing unit 506, an operation state in a predetermined period (information indicating an operation state of the substrate processing apparatus 101 in an area), total power consumption (information of the sum of power consumption of every substrate processing apparatus 101 disposed in the area), total N2 gas consumption (information of the sum of amounts of N2 gas consumed by every substrate processing apparatus 101 disposed in the area), and an average operation rate (information indicating a recipe execution state of every substrate processing apparatus 101 disposed in the area) are created in every area. In this embodiment, while FIG. 6 is configured to be automatically displayed, for example, FIG. 6 may be configured to be displayed when a predetermined button (energy saving button, or the like) indicating an energy saving state is pressed. Subsequently, the flow proceeds to a standby process in which a data display request is awaited (step 6).

Then, when a data display request instruction is received in step 6, the data display contents is checked and a predetermined condition is derived (step 7). A data table is searched based on the derived predetermined condition to acquire predetermined data (step 8), and the acquired data is processed and displayed in a predetermined format (step 9). Thereafter, the flow is returned to step 6 and a next data display request is awaited.

Also, in this embodiment (modification), when a predetermined button of the overview screen of FIG. 6 is pressed, the data analysis program is configured to be executed by the control unit 501. Then, as described in Embodiment 1, the graphs of FIGS. 14 to 16 are displayed. Also, in this embodiment, the information provision program including the data accumulation program and the data analysis program is terminated when the management device 500 is powered off.

Further, log-in processing, which is omitted in the flow of the information provision program including the data accumulation program and the data analysis program of FIG. 21 in this embodiment (modification), may be added.

Moreover, the screen displayed by the information provision program in the present embodiment (modification) is not limited to the overview screen illustrated in FIG. 6 and, for example, the overview screen illustrated in FIG. 20 may also be displayed.

Also, this embodiment (modification) and the present embodiment (in particular, Embodiment 1) are different only in the display flow of the overview screen illustrated in FIG. 6, and the present embodiment (in particular, Embodiment 1) exerts an effect.

Here, in the present embodiment including the modification described above, it is configured such that, after a predetermined item is selected from the overview screen of FIG. 6, when an execution button installed on the same screen is pressed, a data display request instruction may be transmitted to the control unit 501, and the control unit 501, which has received the data display request instruction, may execute the data analysis program.

Furthermore, as well as being applied to a case of performing a film forming process that forms various films such as an oxide film, a nitride film, and a metal film in the processing process, the present disclosure may also be applied to any other cases of processing a substrate such as a diffusion process, an annealing process, a nitriding process, and a lithography process. In addition, as well as being applied to a thin film forming device, the present disclosure may also be applied to any other substrate process devices such as an etching device, an annealing device, an oxidation device, a nitriding device, an exposing device, an application device, a mold device, a developing device, a dicing device, a wire bonding device, a drying device, a heating device, an inspection device, and the like. Also, in the present disclosure, these various substrate processing apparatuses may coexist in a single substrate processing system.

Moreover, the present disclosure may also be applied to a substrate processing apparatus such as a liquid crystal display (LCD) manufacturing apparatus that processes a glass substrate, without being limited to a semiconductor manufacturing apparatus or the like that processes a semiconductor wafer as described above.

### <Aspects of the Present Disclosure>

Hereinafter, some aspects of the present disclosure will be additionally stated as supplementary notes.

### (Supplementary Note 1)

According to one aspect of the present disclosure, there is provided an integrated management system including a substrate processing apparatus configured to process a substrate and a management device, the management device including: an accumulation unit configured to accumulate specified information including power consumption information indicating a power consumed in the substrate processing apparatus, gas consumption information indicating a gas consumed in the substrate processing apparatus, or operation information indicating an operation state of the substrate processing apparatus; and a processing display unit configured to acquire predetermined information that meets a predetermined condition from the specified information accumulated in the accumulation unit and calculate at least one among a power consumption consumed in the substrate processing apparatus, an inert gas consumption, and an operation rate of the substrate processing apparatus based on the predetermined information.

### (Supplementary Note 2)

In the integrated management system of Supplementary Note 1, the substrate processing apparatus may include auxiliary equipment, and the accumulation unit may be configured to acquire information on the substrate processing apparatus and the auxiliary equipment, and accumulate the acquired information in a computer-readable manner.

### (Supplementary Note 3)

In the integrated management system of Supplementary Note 1, the accumulation unit may be configured to: accumulate, as at least the operation information, apparatus-specific information which specifies the substrate processing apparatus in operation, operation time information which specifies an operation start time and an operation stop time of the substrate processing apparatus, and recipe-specific information which specifies a substrate processing recipe executed by the substrate processing apparatus; accumulate, as the power consumption information, apparatus power consumption information of the substrate processing apparatus, and power consumption time information which specifies a power consumption start time and a power consumption stop time of the substrate processing apparatus; and accumulate, as the gas consumption information, inert gas consumption information of a gas supply system and inert gas consumption time information which specifies an inert gas consumption start time and an inert gas consumption stop time.

### (Supplementary Note 4)

In the integrated management system of Supplementary Note 1, the substrate processing apparatus may include a heating unit configured to heat the substrate, an exhaust unit configured to evacuate an interior of a process chamber for processing the substrate in the substrate processing apparatus, and a control unit configured to control the heating unit and the exhaust unit, and wherein the accumulation unit is configured to accumulate, as the power consumption information, heating power consumption information indicating power consumption of the heating unit, heating time information which specifies a power consumption start time and a power consumption stop time of the heating unit, exhaust power consumption information indicating power consumption of the exhaust unit, exhaust time information which specifies a power consumption start time and a power consumption stop time of the exhaust unit, control power consumption information indicating power consumption of the control unit, and control time information which specifies a power consumption start time and a power consumption stop time of the control unit.

### (Supplementary Note 5)

In the integrated management system of Supplementary Note 1, the accumulation unit may be configured to accumulate, as the gas consumption information, process gas consumption information of a gas supply system and process gas consumption time information which specifies a process gas consumption start time and a process gas consumption stop time.

### (Supplementary Note 6)

In the integrated management system of Supplementary Note 1, the processing display unit may be configured to calculate: total operation number of times of the substrate processing apparatus for a predetermined period; a total operation time of the substrate processing apparatus for the predetermined period; an operation rate of the substrate processing apparatus for the predetermined period; total power consumption of the substrate processing apparatus for the predetermined period; total heating power consumption of a heating unit for the predetermined period; total exhaust power consumption of an exhaust unit for the predetermined period; total control power consumption of a control unit for the predetermined period; and total inert gas consumption of a gas supply system for the predetermined period.

### (Supplementary Note 7)

In the integrated management system of Supplementary Note 6, the processing display unit may be configured to generate graphs of the total operation number of times, the total operation time, the operation rate, the total power consumption, the total heating power consumption, the total exhaust power consumption, the total control power consumption, and the total inert gas consumption, and display the generated graphs.

### (Supplementary Note 8)

In the integrated management system of Supplementary Note 6, the processing display unit may be configured to generate graphs of at least two among the total operation number of times, the total operation time, the operation rate, the total power consumption, the total heating power consumption, the total exhaust power consumption, the total control power consumption, and the total inert gas consumption, and display the generated graphs to be compared along a time axis on one screen.

### (Supplementary Note 9)

According to another aspect of the present disclosure, there is provided a management device including: an accumulation unit configured to accumulate specified information including power consumption information indicating a power consumed in a substrate processing apparatus configured to process a substrate, gas consumption information indicating a gas consumed in the substrate processing apparatus, and operation information indicating an operation state of the substrate processing apparatus; and a processing display unit configured to acquire predetermined information that meets a predetermined condition from the specified information accumulated in the accumulation unit and calculate at least one among a power consumption consumed in the substrate processing apparatus, an inert gas consumption, and an apparatus operation rate of the substrate processing apparatus based on the predetermined information.

### (Supplementary Note 10)

According to another aspect of the present disclosure, there is provided a method of displaying information for a substrate processing apparatus, including: accumulating specified information including power consumption information indicating a power consumed in a substrate processing apparatus configured to process a substrate, gas consumption information indicating a gas consumed in the substrate processing apparatus, and operation information indicating an operation state of the substrate processing apparatus; and acquiring predetermined information that meets a predetermined condition from the specified information accumulated in the act of accumulating the specified information, calculating at least one among a power consumption consumed in the substrate processing apparatus, an inert gas consumption, and an apparatus operation rate of the substrate processing apparatus based on the predetermined information, and displaying a calculation result.

### (Supplementary Note 11)

In the method of Supplementary Note 10, the act of accumulating the specified information may include accumulating, as the operation information, apparatus-specific information which specifies the substrate processing apparatus in operation, operation time information which specifies an operation start time and an operation stop time of the substrate processing apparatus, and recipe-specific information which specifies a substrate processing recipe executed by the substrate processing apparatus, and the act of displaying the predetermined information includes calculating the apparatus operation rate of the substrate processing apparatus based on the operation time information and the recipe-specific information, calculating an average value of the apparatus operation rate for a display period of the apparatus operation rate, and displaying a calculated average value.

### (Supplementary Note 12)

In the method of Supplementary Note 11, the apparatus operation rate may be indicative of a ratio of recipe execution time in a day.

### (Supplementary Note 13)

In the method of Supplementary Note 11, the act of displaying the predetermined information may include calculating an average apparatus operation rate by averaging the calculated apparatus operation rate for the substrate processing apparatus in operation, which is specified in the apparatus-specific information, and displaying the calculated average apparatus operation rate.

### (Supplementary Note 14)

In the method of Supplementary Note 11, the recipe-specific information may include at least one among a name of a recipe, an execution start time of the recipe and an execution stop time of the recipe, and a termination state of the recipe (normal termination or abnormal termination), and the like.

### (Supplementary Note 15)

In the method of Supplementary Note 10, the act of displaying the predetermined information may include calculating a total power consumption and a total inert gas consumption by integrating the power consumption and the inert gas consumption calculated for each of the substrate processing apparatus, calculating an average apparatus operation rate by averaging the apparatus operation rate of each of the substrate processing apparatus, and displaying the calculated average apparatus operation rate.

### (Supplementary Note 16)

In the method of Supplementary Note 10, the act of accumulating the specified information may include generating a predetermined data table that stores the specified information, and the act of displaying the predetermined information includes: receiving an instruction to acquire the predetermined information that meets the predetermined condition; repetitively searching the predetermined data table for the predetermined information; and calculating, after the predetermined information is acquired by act of repetitively searching the predetermined data table, at least one among the power consumption consumed in the substrate processing apparatus, the inert gas consumption, and the apparatus operation rate of the substrate processing apparatus, from the predetermined information which is acquired based on the predetermined condition.

### (Supplementary Note 17)

According to another aspect of the present disclosure, there is provided an information provision program executed by a management device configured to manage a substrate processing apparatus for processing a substrate, including: accumulating specified information including power consumption information indicating a power consumed in a substrate processing apparatus, gas consumption information indicating a gas consumed in the substrate processing apparatus, and operation information indicating an operation state of the substrate processing apparatus; and acquiring predetermined information that meets a predetermined condition, calculating at least one among a power consumption consumed in the substrate processing apparatus, an inert gas consumption, and an apparatus operation rate of the substrate processing apparatus based on the predetermined information, and displaying a calculation result.

### (Supplementary Note 18)

According to another aspect of the present disclosure, there is provided an information provision program including: accumulating specified information including power consumption information indicating a power consumed in a substrate processing apparatus, gas consumption information indicating a gas consumed in the substrate processing apparatus, and operation information indicating an operation state of the substrate processing apparatus; acquiring predetermined information that meets a predetermined condition; and calculating at least one among a power consumption consumed in the substrate processing apparatus, an inert gas consumption, and an apparatus operation rate of the substrate processing apparatus based on the predetermined information, and displaying a calculation result.

### (Supplementary Note 19)

According to another aspect of the present disclosure, there is an information provision program including: accumulating specified information including power consumption information indicating a power consumed in a substrate processing apparatus, gas consumption information indicating a gas consumed in the substrate processing apparatus, and operation information indicating an operation state of the substrate processing apparatus by generating a predetermined data table including the specified information; receiving an instruction to acquire predetermined information that meets a predetermined condition and repetitively searching the predetermined data table for the predetermined information; terminating the act of searching for the predetermined information; and calculating at least one among a power consumption consumed in the substrate processing apparatus, an inert gas consumption, and an apparatus operation rate of the substrate processing apparatus, from the predetermined information which is acquired based on the predetermined condition, and displaying a calculation result.

### (Supplementary Note 20)

According to another aspect of the present disclosure, there is provided a non-transitory computer-readable recording medium storing an information provision program that causes a management device configured to manage a substrate processing apparatus for processing a substrate, to perform: accumulating specified information including power consumption information on power consumed in the substrate processing apparatus, gas consumption information on gas consumed in the substrate processing apparatus, or operation information on an operation state of the substrate processing apparatus; and acquiring information that meets a predetermined condition, calculating at least one among power consumption consumed in the substrate processing apparatus, inert gas consumption, and an operation rate of the substrate processing apparatus, and displaying a calculation result.

### (Supplementary Note 21)

According to another aspect of the present disclosure, there is provided a computer-readable recording medium storing an information provision program including: accumulating specified information including power consumption information indicating a power consumed in a substrate processing apparatus, gas consumption information indicating a gas consumed in the substrate processing apparatus, and operation information indicating an operation state of the substrate processing apparatus; acquiring predetermined information that meets a predetermined condition; and calculating at least one among a power consumption consumed in the substrate processing apparatus, an inert gas consumption, and an apparatus operation rate of the substrate processing apparatus based on the predetermined information, and displaying a calculation result.

### (Supplementary Note 22)

According to another aspect of the present disclosure, there is provided a computer-readable recording medium storing an information provision program, including: accumulating specified information including power consumption information indicating a power consumed in a substrate processing apparatus, gas consumption information indicating a gas consumed in the substrate processing apparatus, and operation information indicating an operation state of the substrate processing apparatus by generating a predetermined data table including the specified information; receiving an instruction to acquire predetermined information that meets a predetermined condition and repetitively searching the predetermined data table for the predetermined information; terminating acquisition of the predetermined information by searching for the predetermined information; and calculating at least one among a power consumption consumed in the substrate processing apparatus, an inert gas consumption, and an apparatus operation rate of the substrate processing apparatus, from the predetermined information which is acquired based on the predetermined condition, and displaying a calculation result.

### (Supplementary Note 23)

According to another aspect of the present disclosure, there is provided a computer-readable recording medium storing a data analysis program including: receiving an instruction to acquire predetermined information that meets a predetermined condition; repetitively searching a predetermined data table that defines specified information including power consumption information indicating a power consumed in a substrate processing apparatus, gas consumption information indicating a gas consumed in the substrate processing apparatus, and operation information indicating an operation state of the substrate processing apparatus; terminating acquisition of the predetermined information by searching for the predetermined information; and calculating at least one among a power consumption consumed in the substrate processing apparatus, an inert gas consumption, and an apparatus operation rate of the substrate processing apparatus, from the predetermined information which is acquired based on the predetermined condition, and displaying a calculation result.

### (Supplementary Note 24)

According to another aspect of the present disclosure, there is provided a data analysis program including: receiving an instruction to acquire predetermined information that meets a predetermined condition; repetitively searching g a predetermined data table that defines specified information including power consumption information indicating a power consumed in a substrate processing apparatus, gas consumption information indicating a gas consumed in the substrate processing apparatus, and operation information indicating an operation state of the substrate processing apparatus; terminating acquisition of the predetermined information by searching for the predetermined information; and calculating at least one among a power consumption consumed in the substrate processing apparatus, an inert gas consumption, and an apparatus operation rate of the substrate processing apparatus, from the predetermined information which is acquired based on the predetermined condition, and displaying a calculation result.

This application is based upon and claims the benefit of priority from Japanese Patent Application No. 2012-212553, filed on Sep. 26, 2012, the entire contents of which are incorporated herein by reference.

### INDUSTRIAL APPLICABILITY

According to the present disclosure in some embodiments, it is possible to provide an integrated management system, a management device, and a method of displaying information for a substrate processing apparatus, which are capable of accumulating various data collected from each substrate processing apparatus installed in a semiconductor manufacturing factory, processing the accumulated data into data required to save energy for each substrate processing apparatus, and displaying the same.

[Description of the reference numerals]

| | |
|---|---|
| 101: substrate processing apparatus | 200: wafer (substrate) |
| 500: management device | 505: accumulation unit |
| 506: processing display unit | |

1. An integrated management system comprising a substrate processing apparatus configured to process a substrate and a management device, the management device including:
an accumulation unit configured to accumulate specified information including power consumption information indicating a power consumed in the substrate processing apparatus, gas consumption information indicating a gas consumed in the substrate processing apparatus, or operation information indicating an operation state of the substrate processing apparatus; and
a processing display unit configured to acquire predetermined information that meets a predetermined condition from the specified information accumulated in the accumulation unit and calculate at least one among a power consumption consumed in the substrate processing apparatus, an inert gas consumption, and an operation rate of the substrate processing apparatus based on the predetermined information.

2. A management device comprising:
an accumulation unit configured to accumulate specified information including power consumption information indicating a power consumed in a substrate processing apparatus configured to process a substrate, gas consumption information indicating a gas consumed in the substrate processing apparatus, and operation information indicating an operation state of the substrate processing apparatus; and
a processing display unit configured to acquire predetermined information that meets a predetermined condition from the specified information accumulated in the accumulation unit and calculate at least one among a power consumption consumed in the substrate processing apparatus, an inert gas consumption, and an apparatus operation rate of the substrate processing apparatus based on the predetermined information.

3. A method of displaying information for a management device configured to manage a substrate processing apparatus configured to process a substrate, the management device comprising:
an accumulation unit configured to accumulate specified information including power consumption information indicating a power consumed in the substrate processing apparatus, gas consumption information indicating a gas consumed in the substrate processing apparatus, and operation information indicating an operation state of the substrate processing apparatus; and
a display unit configured to acquire predetermined information that meets a predetermined condition from the specified information accumulated in the accumulation unit, calculate at least one among a power consumption consumed in the substrate processing apparatus, an inert gas consumption, and an apparatus operation rate of the substrate processing apparatus based on the predetermined information, and display a calculation result.

4. The method of claim 3, wherein the accumulation unit is configured to accumulate, as the operation information, apparatus-specific information which specifies the substrate processing apparatus in operation, operation time information which specifies an operation start time and an operation stop time of the substrate processing apparatus, and recipe-specific information which specifies a substrate processing recipe executed by the substrate processing apparatus, and
wherein the display unit is configured to calculate the apparatus operation rate of the substrate processing apparatus based on the operation time information and the recipe-specific information, calculate an average value of the apparatus operation rate for a display period of the apparatus operation rate, and displays a calculated average value.

5. The method of claim 4, wherein the apparatus operation rate is indicative of a ratio of a recipe execution time in a day.

6. The method of claim 4, wherein the display unit is configured to calculate an average apparatus operation rate by averaging the calculated apparatus operation rate for the substrate processing apparatus in operation, which is specified in the apparatus-specific information, and display the calculated average apparatus operation rate.

7. The method of claim 4, wherein the recipe-specific information includes at least one among a name of a recipe, an execution start time of the recipe and an execution stop time of the recipe, and a termination state of the recipe includes at least one between a normal termination and an abnormal termination.

8. The method of claim 3, wherein the substrate processing apparatus includes a plurality of substrate processing apparatuses, and
wherein the display unit is configured to calculate a total power consumption and a total inert gas consumption by integrating the power consumption and the inert gas consumption calculated for each of the substrate processing apparatuses, calculate an average apparatus operation rate by averaging the apparatus operation rate of each of the substrate processing apparatuses, and display the calculated average apparatus.

9. The method of claim 3, wherein the accumulation unit is configured to generate a predetermined data table that stores the specified information, and
wherein the display unit is configured to:
receive an instruction to acquire the predetermined information that meets the predetermined condition;
repetitively search the predetermined data table for the predetermined information; and
calculate, after the predetermined information is acquired by the act of repetitively searching the predetermined data table, at least one among the power consumption consumed in the substrate processing apparatus, the inert gas consumption, and the apparatus operation rate of the substrate processing apparatus, from the predetermined information which is acquired based on the predetermined condition.

10. (canceled)

11. The integrated management system of claim 1, wherein the substrate processing apparatus includes auxiliary equipment, and
wherein the accumulation unit is configured to acquire information indicating the substrate processing apparatus and the auxiliary equipment, and accumulate the acquired information in a computer-readable manner.

12. The integrated management system of claim 1, wherein the accumulation unit is configured to:
accumulate, as at least the operation information, apparatus-specific information which specifies the substrate processing apparatus in operation, operation time information which specifies an operation start time and an operation stop time of the substrate processing apparatus, and recipe-specific information which specifies a substrate processing recipe executed by the substrate processing apparatus;
accumulate, as the power consumption information, apparatus power consumption information of the substrate processing apparatus, and power consumption time information which specifies a power consumption start time and a power consumption stop time of the substrate processing apparatus; and
accumulate, as the gas consumption information, inert gas consumption information of a gas supply system and inert gas consumption time information which specifies an inert gas consumption start time and an inert gas consumption stop time.

13. The integrated management system of claim 1, wherein the substrate processing apparatus includes a heating unit configured to heat the substrate, an exhaust unit configured to evacuate an interior of a process chamber for processing the substrate in the substrate processing apparatus, and a control unit configured to control the heating unit and the exhaust unit, and
wherein the accumulation unit is configured to accumulate, as the power consumption information, heating power consumption information indicating a power consumption of the heating unit, heating time information which specifies a power consumption start time and a power consumption stop time of the heating unit, exhaust power consumption information indicating a power consumption of the exhaust unit, exhaust time information which specifies a power consumption start time and a power consumption stop time of the exhaust unit, control power consumption information indicating a power consumption of the control unit, and control time information which specifies a power consumption start time and a power consumption stop time of the control unit.

14. The integrated management system of claim 1, wherein the accumulation unit is configured to accumulate, as the gas consumption information, process gas consumption information of a gas supply system and process gas consumption time information which specifies a process gas consumption start time and a process gas consumption stop time.

15. The integrated management system of claim 1, wherein the processing display unit is configured to calculate: total operation number of times of the substrate processing apparatus for a predetermined period; a total operation time of the substrate processing apparatus for the predetermined period; an operation rate of the substrate processing apparatus for the predetermined period; a total power consumption of the substrate processing apparatus for the predetermined period; a total heating power consumption of a heating unit for the predetermined period; a total exhaust power consumption of an exhaust unit for the predetermined period; a total control power consumption of a control unit for the predetermined period; and a total inert gas consumption of a gas supply system for the predetermined period.

16. The integrated management system of claim 15, wherein the processing display unit is configured to generate a graph of at least one among the total operation number of times, the total operation time, the operation rate, the total power consumption, the total heating power consumption, the total exhaust power consumption, the total control power consumption, and the total inert gas consumption, and display the generated graph.

17. The integrated management system of claim 15, wherein the processing display unit is configured to generate graphs of at least two among the total operation number of times, the total operation time, the operation rate, the total power consumption, the total heating power consumption, the total exhaust power consumption, the total control power consumption, and the total inert gas consumption, and display the generated graphs to be compared along a time axis on one screen.
